(19) United States
(12) Patent Application Publication
(10) Pub. No.: US 2016/0333579 A1
(43) Pub. Date: Nov. 17, 2016

(54) Connector

(71) Applicant: SAINT-GOBAIN PLACO SAS, Suresnes (FR)

(72) Inventor: Colin Stein, Coventry (GB)

(73) Assignees: Saint-Gobain Placo SAS, Suresnes (FR); Saint-Gobain Placo SAS, Suresnes (FR)

(21) Appl. No.: 15/109,273

(22) PCT Filed: Dec. 24, 2014
(86) PCT No.: PCT/EP2014/079322

§ 371 Date: Jun. 30, 2016

(30) Foreign Application Priority Data
Jan. 2, 2014 (GB) 1400028.5

(51) Int. Cl. E04B 2/76; F16B 21/02; F16B 7/04

(52) U.S. Cl. CPC E04B 2/767; F16B 7/0446; F16B 21/02; E04B 2/765; E04B 2002/7488

(57) ABSTRACT

A connector for connecting together first and second elongate members is described. Each of the members to be joined by the connector comprises an open channel extending along the member, the channel having an opening along one side of the member and being partially enclosed by a lip extending along the opening. The connector comprises a first end portion and a second end portion. The first end portion is shaped to fit into the channel of the first member via one end of the first member. The second end portion is shaped to achieve one of two types of engagement with another channel. Firstly, it may be shaped to permit its insertion into the channel of the second member via the opening when the connector is in a first rotational position with respect to the second member. In this case, the second end portion comprises an engagement structure which is shaped to engage with the lip of the second member when the inserted connector is rotated within the channel from the first rotational position into a second rotational position with respect to the second member. Alternatively, it may be shaped to permit its insertion under pressure into the channel of the second member via the opening. In this case, the second end portion comprises a first engagement structure (e.g. a groove) which is shaped to engage with a second engagement structure (e.g. the lip) of the second member when the second end of the connector has been inserted through the opening. In this way, the first and second elongate members (which might be floor/ceiling channels and vertical studs respectively for example) can be of the same profile. As a result, a single metal profile can act as stud, channel, noggin and door head. Furthermore, a single connector type can be used to form all the connections required between these elements.

### FIELD OF THE INVENTION

The present invention relates to a connector for connecting together first and second elongate members. Embodiments of the present invention relate more particularly to a connector for joining elongate structures such as ceiling/floor channels, studs and noggins to form a wall, ceiling, floor or other frame structure.

### BACKGROUND TO THE INVENTION

In the construction of stud walls, C shaped horizontal channels are fixed to a ceiling and a floor, and vertical studs of profiled metal are urged into the C shaped channels, and may be fixed in place. Where required, horizontal noggins of profiled metal may be provided between the studs to lend rigidity to the resulting structure. The noggins may be shaped to fit around the outside of the vertical studs. Boards are then fixed to the structure, binding it together and forming a wall surface. This conventional construction methodology suffers from a number of disadvantages, including the requirement to use different metal profiles and/or joins for each of the horizontal channels, vertical studs and horizontal noggins. Yet further structures may be required in order to build frames around doorways, and provide fixing points for patresses. Previous solutions to these problems tend to require a high degree of cutting accuracy and/or result in a non-flush finish which is more difficult to mount plasterboard over.

Embodiments of the present invention seek to address these problems.

### SUMMARY OF THE INVENTION

According to an aspect of the present invention, there is provided a connector for connecting together first and second elongate members, each of the members comprising an open channel extending along the member and being partially enclosed by a lip extending along the opening, the channel having an opening along one side of the member, the connector comprising:

a first end portion shaped to fit into the channel of the first member via one end of the first member; and

a second end portion shaped to permit its insertion into the channel of the second member via the opening when the connector is in a first rotational position with respect to the second member, the second end portion comprising a first engagement structure which is shaped to engage with the lip of the second member when the inserted connector is rotated within the channel from the first rotational position into a second rotational position with respect to the second member.

In this way, the first and second elongate members (which might be floor/ceiling channels and vertical studs respectively for example) can be of the same profile. As a result, a single simple metal profile can act as stud, channel, noggin and door head (and as explained later may also be used to support the installation of a patress). Furthermore, a single connector type can be used to form all the connections required between these elements. The first and second elongate members may be C channels, or other “open” channels. The principle of inserting the connector in a first rotational position into the channel and then rotating it into engagement with the lip is referred to herein as “twist-locking”.

It will be appreciated that, while the first end portion is shaped to fit into the channel of the first member via one end of the first member, it may in some cases be snapped into the channel via the opening—that is, the lips may be caused to deflect apart to enable the first end portion to enter the channel in the vicinity of the end of the channel. Moreover, the entirety of the connector could be inserted into the channel in this way, for example to utilise the connector as a solid fixing point at a mid-point (or any other position) along the channel. In this regard, the connector could be inserted via the end of the channel and slid along to a desired position. This may be advantageous during installation of a stud wall in certain circumstances. It will however be appreciated that at least part of the connector is required to be shaped to fit through the end of the channel, so that the second portion can protrude from the channel to engage with another channel.

The channel may comprise a base wall opposite to the opening, and side walls extending from the base wall to the side of the channel may bear the opening, wherein the second engagement structure is provided on one or both of the side walls.

One or both of the side walls may comprise a ridge or groove which forms the second engagement structure, and the first engagement structure may comprise a groove or ridge.

The second end portion may be dimensioned to be trapped within the channel by the lip when the connector is rotated within the channel.

Preferably, the engagement structure comprises a groove which is shaped and positioned to engage with the lip when the connector is inserted into the channel and rotated from the first rotational position into the second rotational position. Preferably, the groove extends around at least a portion of the connector at a distance from an end of the connector less than or equal to the depth of the channel. The grooves may be only on (or near) the narrow side of the connector, or may be provided both on the narrow and wide sides.

In one embodiment, the groove comprises a gripping formation for gripping the lip when the connector is in its first rotational position. In this case the groove carrying the gripping formation is on the wide side of the connector.

The cross section of the first end portion may be dimensioned to substantially match the internal cross section of the channel, and the cross section of the second end portion may have a first dimension which is less than or equal to the width of the opening to the channel and a second dimension perpendicular to the first dimension which is greater than the width of the opening to the channel.

The second dimension may be substantially equal to the internal width of the channel, such that the second end portion of the connector substantially fills the width of the channel when the connector is in its second rotational position.

Preferably, the angular displacement of the second rotational position from the first rotational position is 90□.

Preferably, the cross section of the second end portion is generally rectangular, and at least two opposite edges of the connector along at least a portion of its length are bevelled to permit rotation of the second end portion within the channel. In some embodiments, all four edges are bevelled to permit rotation both clockwise and anti-clockwise.

In addition to being engageable via the opening, the second end portion may be engageable with the channel via a cut out in a face of the second member opposite to the face in which the opening is provided. This permits connectors to be used to join members to both of two opposing faces of another member.

The engagement structure may comprise a tapered slot (notch) which is shaped and positioned to engage with the lip when the connector is inserted in to the channel and rotated from the first rotational position to the second rotational position. The tapered shape serves to guide the lip as it enters the notch into a narrow portion of the slit which grips both sides of the lip. Preferably, two notches are provided, one in each of two opposite edges of the connector. However, four notches could instead be provided (one on each edge).

Preferably, the first end portion and the second end portion have substantially the same shape. In other words, the connector may be substantially uniform in cross section along its entire length. This permits the connector to slide to any position within an elongate member to be used as a convenient fixing point for screwing to. This also permits the two ends of the connector to have different functions when exposed beyond the ends of the channel (for example, both ends may be suitable for slide fitting into the end of a channel, while one of those ends may be suitable to provide a twist-locking perpendicular fix into another channel, while the other of those ends may be suitable to provide a push-locking angled fit (e.g. for a range of angles of between 32° and 45°). It will be appreciated that other combinations are also possible.

The connector may comprise a channel or cavity for permitting electrical wiring/cabling and/or pipes to pass through a joint, formed by the connector, between the first and second members.

One or both of the first end and the second end of the connector may have a radiused or chamfered leading edge to facilitate insertion into the first and/or second elongate members.

The first end may comprise one or more external ribs, pips, textured surfaces or other structures for providing friction engagement with the inside of the channel of the first elongate member.

The first end may comprise a plurality of slots extending from an end face of the first end of the connector longitudinally of the connector.

The first end of the connector and the second end of the connector may be hingedly connected together.

The connector may be formed of two separate moulded components, one of the components comprising the first and a first hinge part, and the other of the components comprising the second end and a second hinge part, the first hinge part and the second hinge part being engageable to permit the angle between the first end and the second end to be adjusted.

Each of the first and second parts may comprise mutually engaging formations or textured surfaces which can be engaged with each other at different angles.

The first end may be provided with markings indicating a minimum insertion depth for the first end into the first member.

The leading face of the second end may comprise hollows or cutouts for clearing screwheads within the channel of the second member.

The second end may comprise a further engagement structure nearer to its leading face.

The first end may have a curved and sloped leading face which can abut a base wall of the channel at a range of angles.

The curved and sloped leading face bears a slot for receiving a screw to fix the connector to the base of the channel at a desired angle of the range of angles.

The first end may comprise one or more formations, shaped and positioned to interact with the lip of the channel to restrict the connector, when its sloped leading face is within the channel, from having an angle with respect to the channel of greater than a first predetermined angle and/or less than a second predetermined angle. The first predetermined angle may be approximately 45° and the second predetermined angle may be approximately 32°. The connector may be inhibited from exceeding the first predetermined angle when the lip is in contact with one of the formations and the leading edge of the connector is in contact with the base of the channel. The formations may comprise a first formation and a second formation, and the connector may be inhibited from having an angle less than the predetermined angle when the lip is trapped between the first and second formations.

While for an elongate member having a lip (generally on each side of the opening) this forms a suitable structure for engaging with a corresponding structure—generally a groove or a slot—of the connector, in some cases it may be desirable to use an elongate member which does not have a lip, or which has another structure which can be engaged by the connector. For example, where the channel comprises a base wall opposite to the opening, and side walls extending from the base wall to the side of the channel bearing the opening, engagement structures may be provided on one or both of the side walls, inside the channel. For example, one or both of the side walls may comprise a ridge or groove which forms an engagement structure, with the engagement structure of the connector comprising a groove or ridge which is complementary in shape to, or is otherwise able to engage with, the ridge or groove in the side walls of the channel.

According to another aspect of the present invention, there is provided a connector for connecting together first and second elongate members, each of the members comprising an open channel extending along the member, the channel having an opening along one side of the member, the connector comprising:

a first end portion shaped to fit into the channel of the first member via one end of the first member; and

a second end portion shaped to permit its insertion under pressure into the channel of the second member via the opening, the second end portion comprising a first engagement structure which is shaped to engage with a second engagement structure of the second member when the second end of the connector has been inserted through the opening.

The opening along one side of the member may be partially enclosed by a lip extending along the opening, wherein the lip is the second engagement structure.

The principle of inserting the connector into the channel under pressure to engage a first engagement structure (of the connector) with a second engagement structure (of the channel) is referred to herein as “push-locking”. Similarly to the twist-lock embodiment, in the push-lock embodiment the first and second elongate members (which might be floor/ceiling channels and vertical studs respectively for example) can be of the same profile. As a result, a single simple metal profile can act as stud, channel, noggin and door head or patress. Furthermore, a single connector type can be used to form all the connections required between these elements. The first and second elongate members may be C channels, or other “open” channels.

The second end portion may have a curved and sloped leading face which can abut a base wall of the channel at a range of angles. The curved and sloped leading face may bear a slot for receiving a screw to fix the connector to the base of the channel at a desired angle of the range of angles.

The second end may comprise one or more formations, shaped and positioned to interact with the lip of the channel to restrict the connector, when its sloped leading face is within the channel, from having an angle with respect to the channel of greater than a first predetermined angle and/or less than a second predetermined angle. The first predetermined angle may be approximately 45° and the second predetermined angle may be approximately 32°. The connector may be inhibited from exceeding the first predetermined angle when the lip is in contact with one of the formations and the leading edge of the connector is in contact with the base of the channel. The formations may comprise a first formation and a second formation, and the connector may be inhibited from having an angle less than the predetermined angle when the lip is trapped between the first and second formations.

The engagement structure may comprise a groove which is shaped and positioned to engage with the lip when the second end of the connector is inserted a predetermined distance through the opening.

The groove may extend around at least a portion of the connector at a distance from an end of the connector substantially equal to the depth of the channel.

The second end may comprise a ramped leading end which displaces the lips of the channel apart as the connector is urged into the channel, wherein the groove is disposed behind the ramp.

The second end of the connector may comprise an end plate which rests against the inside surface of the channel opposite to the opening when the second end of the connector is fully inserted through the opening. The end plate may be provided with fixing holes for fixing the connector to or through the surface of the channel against which the end plate rests. The end plate may be shaped and dimensioned to rest in a recess in an external face of the second member opposite to the face in which the opening is provided.

The second end may comprise a plurality of barbs for engaging with the inside side walls of the channel of the second member.

Any of the connectors may be formed of moulded plastic.

According to another aspect of the present invention, there is provided a frame structure, comprising a plurality of elongate members joined together by one or more connectors according to the above. According to another aspect of the present invention, there is provided a wall, ceiling or floor comprising this frame structure.

According to another aspect of the present invention, there is provided a method of connecting together first and second elongate members, each of the members comprising an open channel extending along the member, the channel having an opening along one side of the member and being partially enclosed by a lip extending along the opening, the method comprising the steps of:

sliding a shaped first end portion of the connector into the channel of the first member via one end of the first member;

inserting a shaped second end portion into the channel of the second member via the opening with the connector in a first rotational position with respect to the second member; and

rotating the inserted connector within the channel from the first rotational position into a second rotational position with respect to the second member so that an engagement structure of the connector engages with the lip of the second member.

When in the second rotational position, it need not be necessary for the second end portion to completely fill the width of the channel, provided that the dimensions of the second end portion are such that the lips of the member penetrate into the groove when the connector is in the second rotational position. In fact, it may be difficult to dimension the second end portion of the connector to completely fill the width and/or the depth of the channel due to the problem of rotating a square cross section within a square enclosure of the same dimensions. Deformation of one or both of the connector (which may be made of a slightly compressible material) and the channel (the side walls of the channel may be forced outwards to some degree near the opening face of the member) may permit the second end portion to have a greater dimension than might otherwise be the case. The benefit of deformation may be assisted by providing that the second end portion of the connector does not completely fill the channel to its full depth—since the part of the side walls distal to the opening in the member will deform less than the part near to the opening, or not at all.

According to another aspect of the present invention, there is provided a method of connecting together first and second elongate members, each of the members comprising an open channel extending along the member, the channel having an opening along one side of the member, the method comprising the steps of:

sliding a shaped first end portion of the connector into the channel of the first member via one end of the first member;

inserting under pressure a shaped second end portion into the channel of the second member via the opening, the second end portion comprising a first engagement structure which is shaped to engage with a second engagement structure of the second member when the second end of the connector has been inserted through the opening.

While it is preferable for the connector to be used wherever possible in a frame structure, in some cases the connector may only be used where a slideable connection is particularly beneficial. For example, it may be be possible to use the connector at the top or the bottom of a stud, but to fix directly or via a different form of connector at the other end.

It will be appreciated that the connector could be formed from one or more of various different materials. The connector could be formed of wood, high density plastic, metal, composite material or gypsum for example.

### DETAILED DESCRIPTION

The invention will now be described by way of example with reference to the following Figures in which:

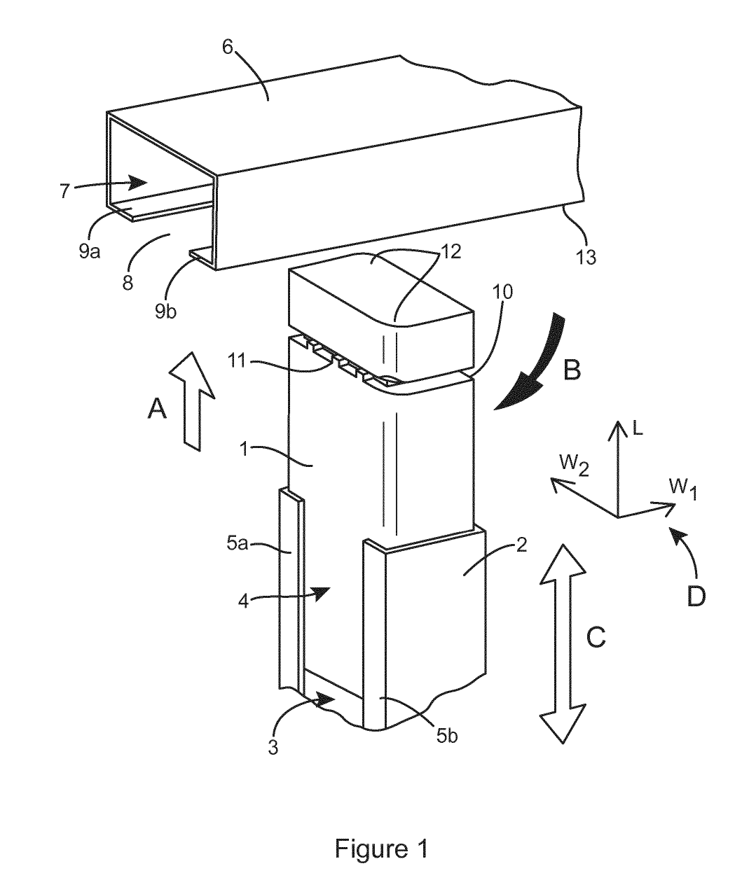

FIG. 1 shows a schematic view of a connector according to a first embodiment of the invention;

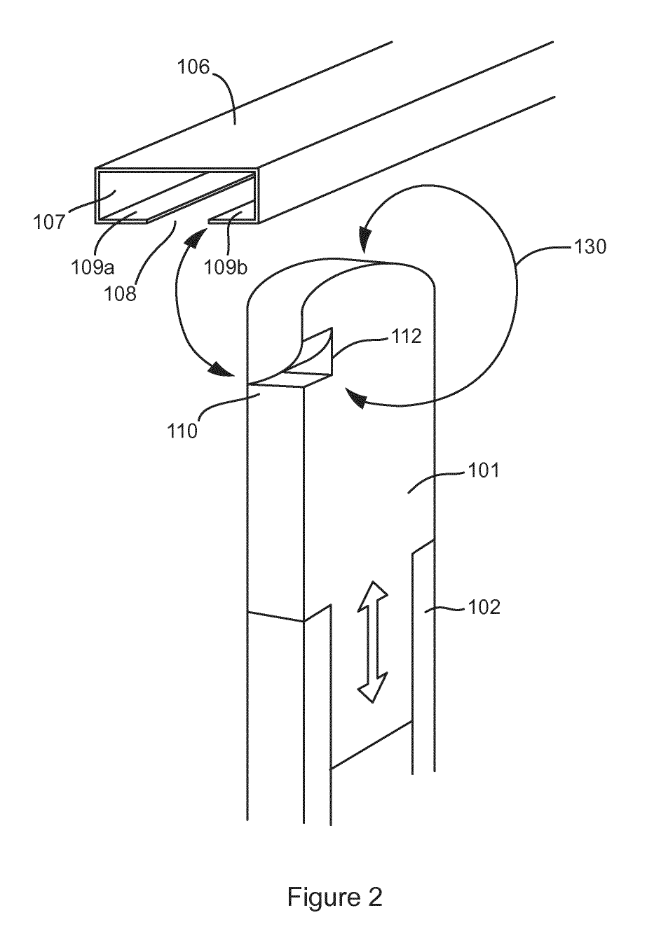

FIG. 2 shows a schematic view of a connector according to a second embodiment of the invention;

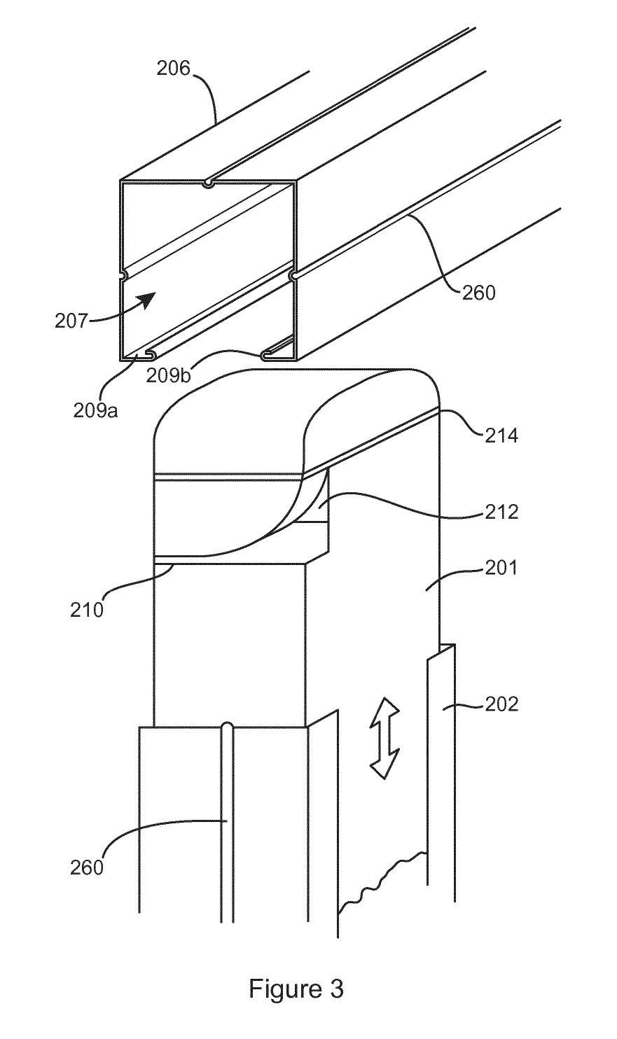

FIG. 3 schematically shows a connector according to a third embodiment of the invention;

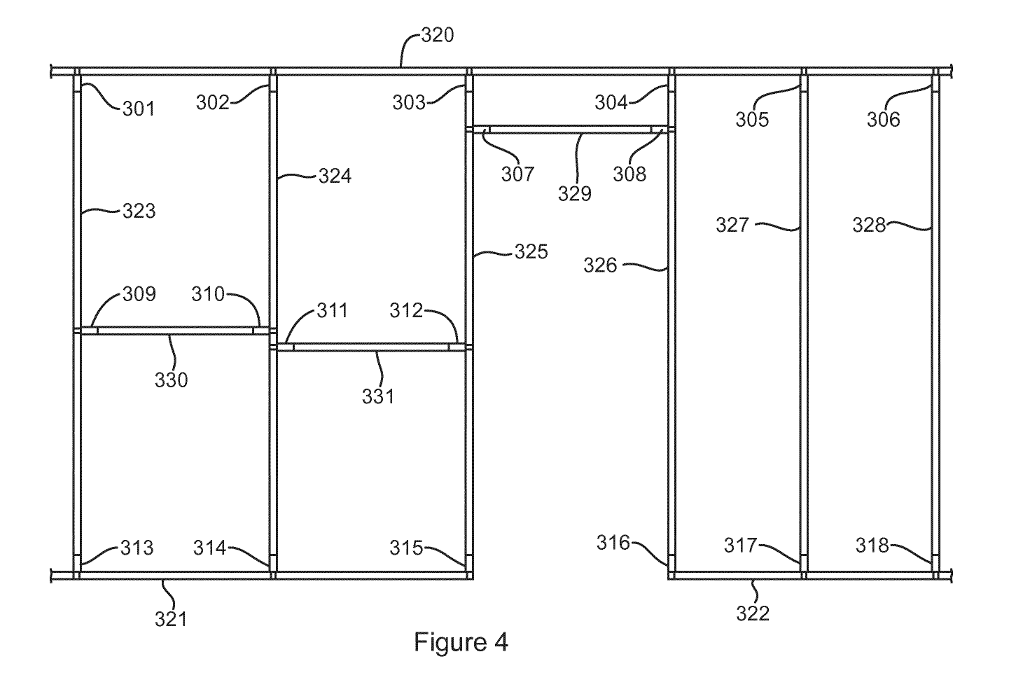

FIG. 4 schematically shows a stud wall constructed using connectors and C channels according to an embodiment of the invention;

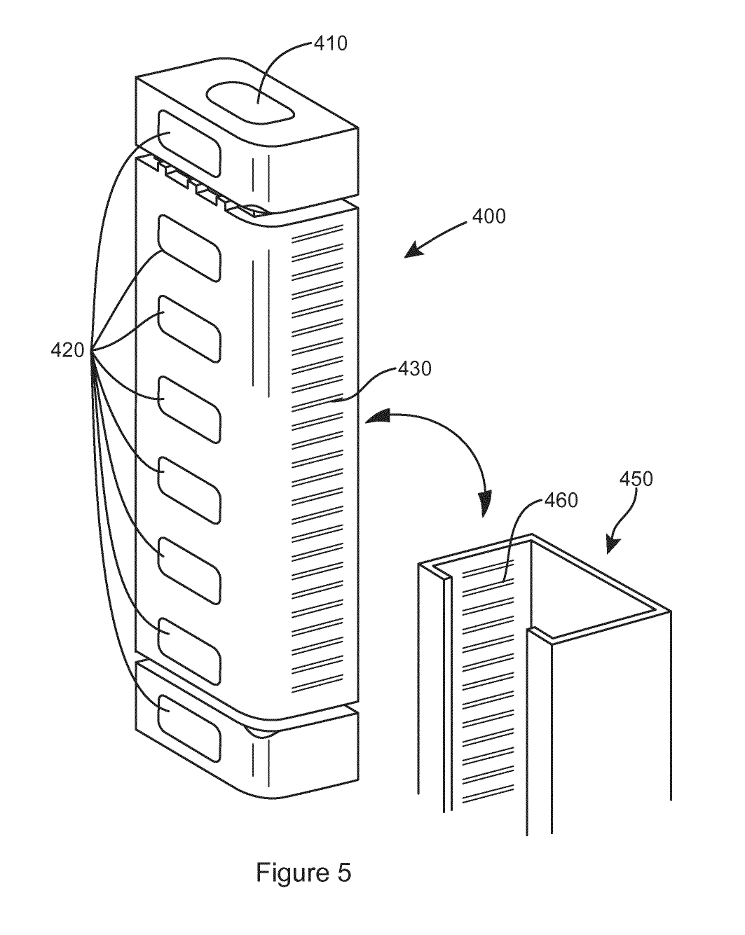

FIG. 5 schematically shows a connector having openings for permitting the passage of cables and/or pipes through it;

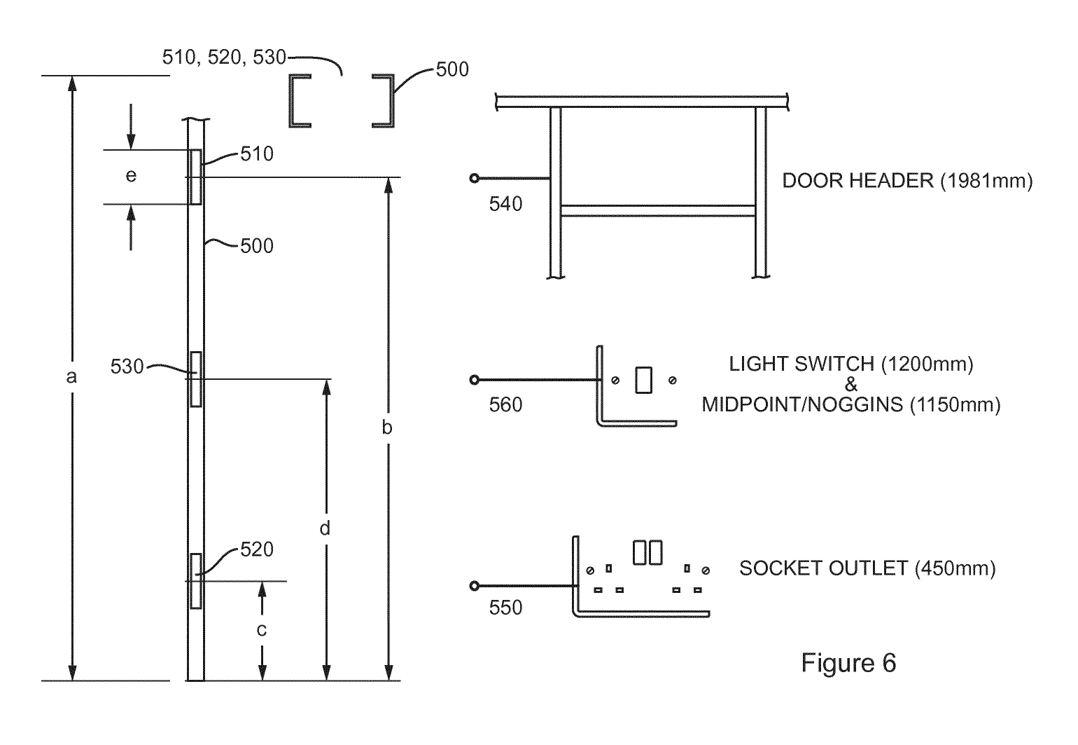

FIG. 6 schematically shows a C-shaped construction member having cut-outs for permitting a connector to access the channel of the member;

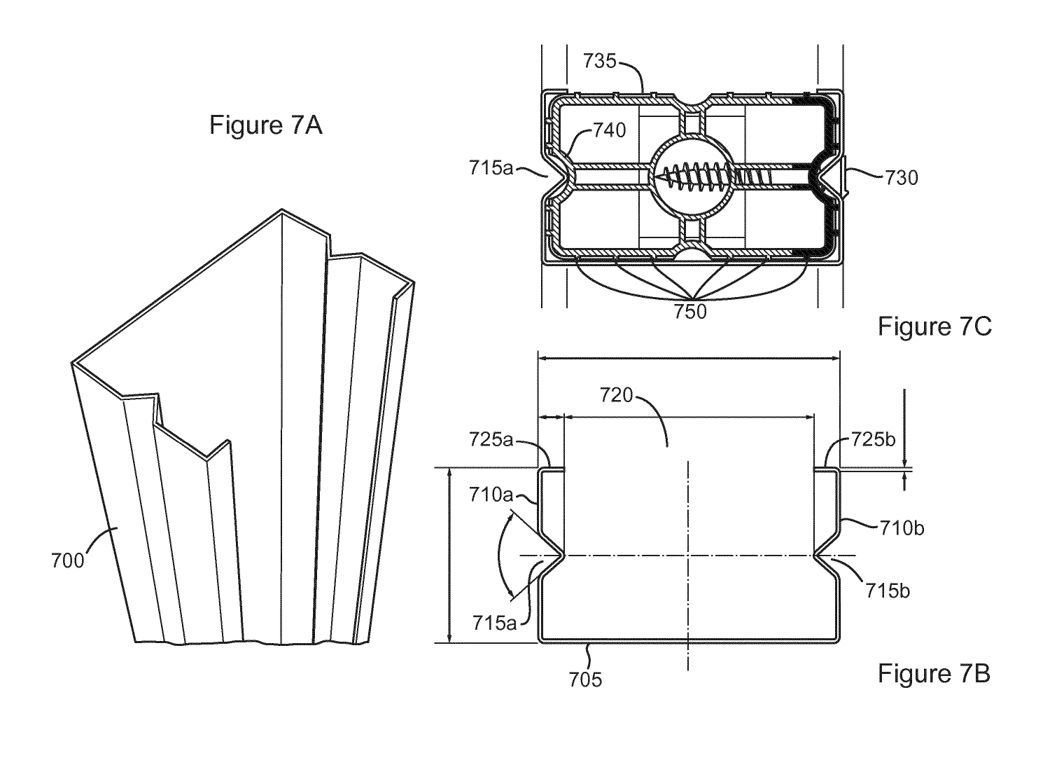

FIGS. 7A to 7C schematically illustrate a modified section profile;

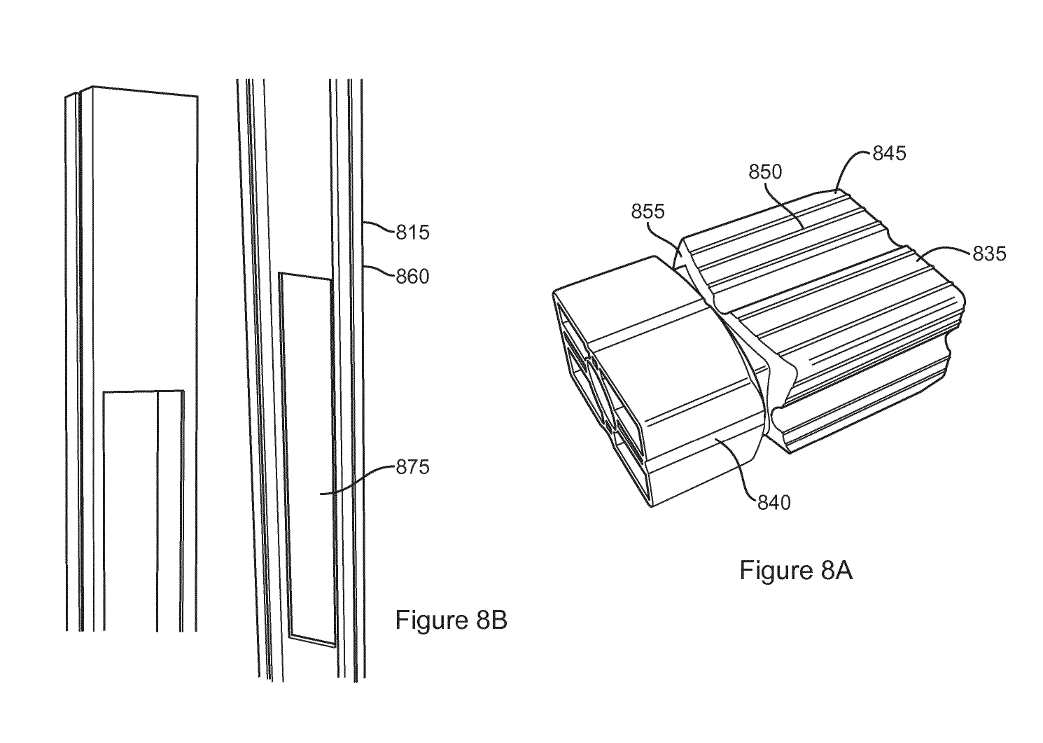

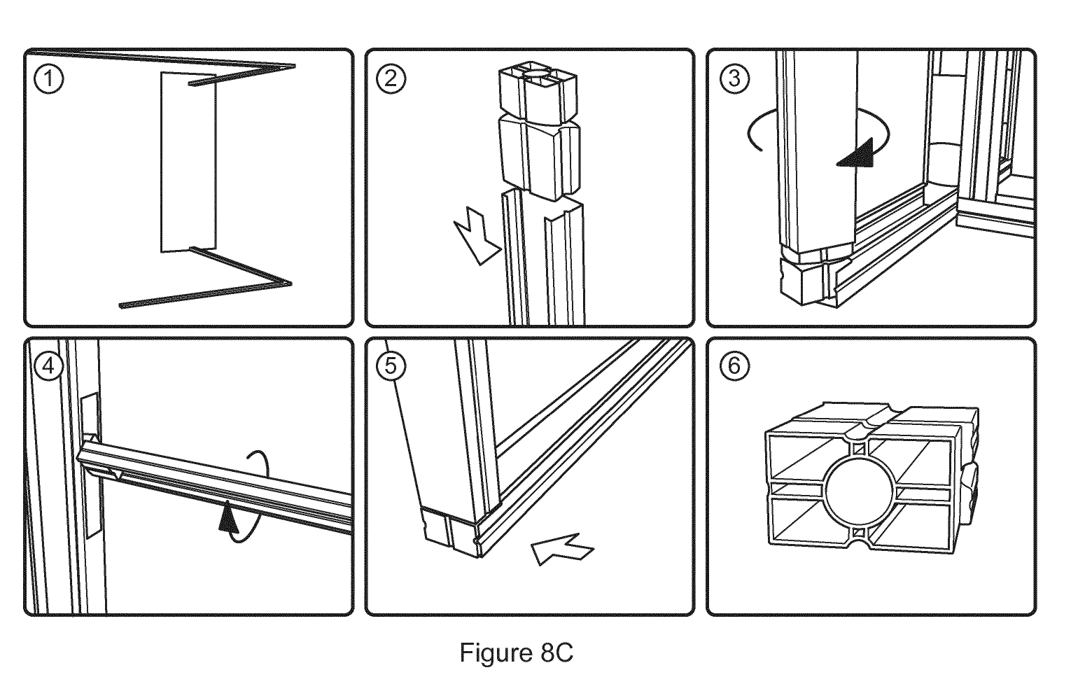

FIGS. 8A to 8C schematically illustrate a twist-type connector according to a third embodiment;

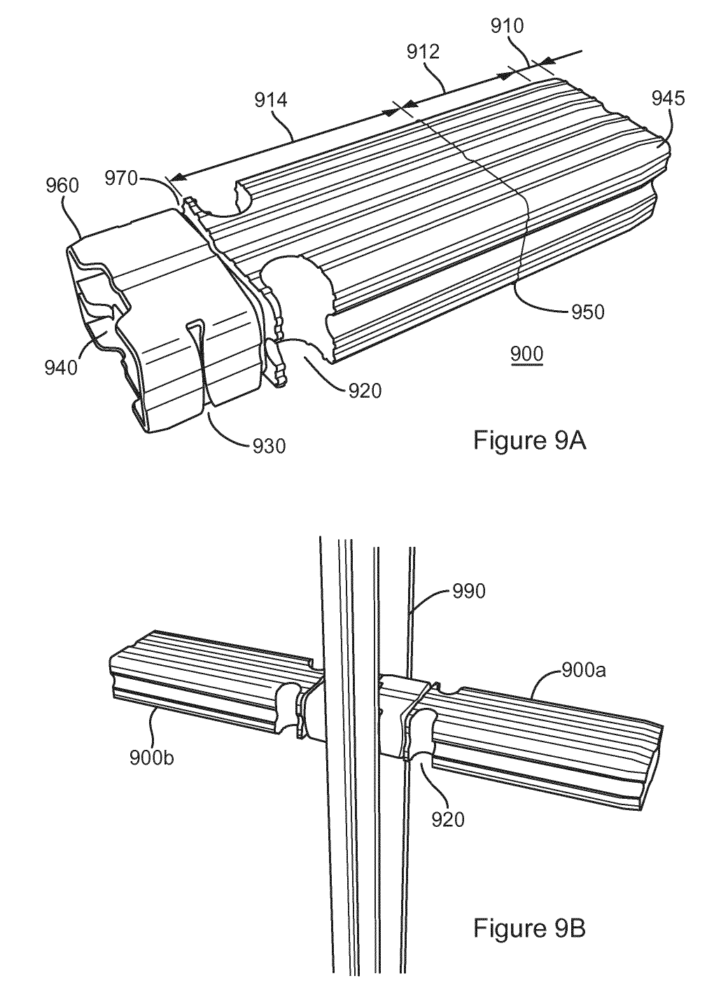

FIGS. 9A and 9B schematically illustrate a twist-type connector according to a fourth embodiment;

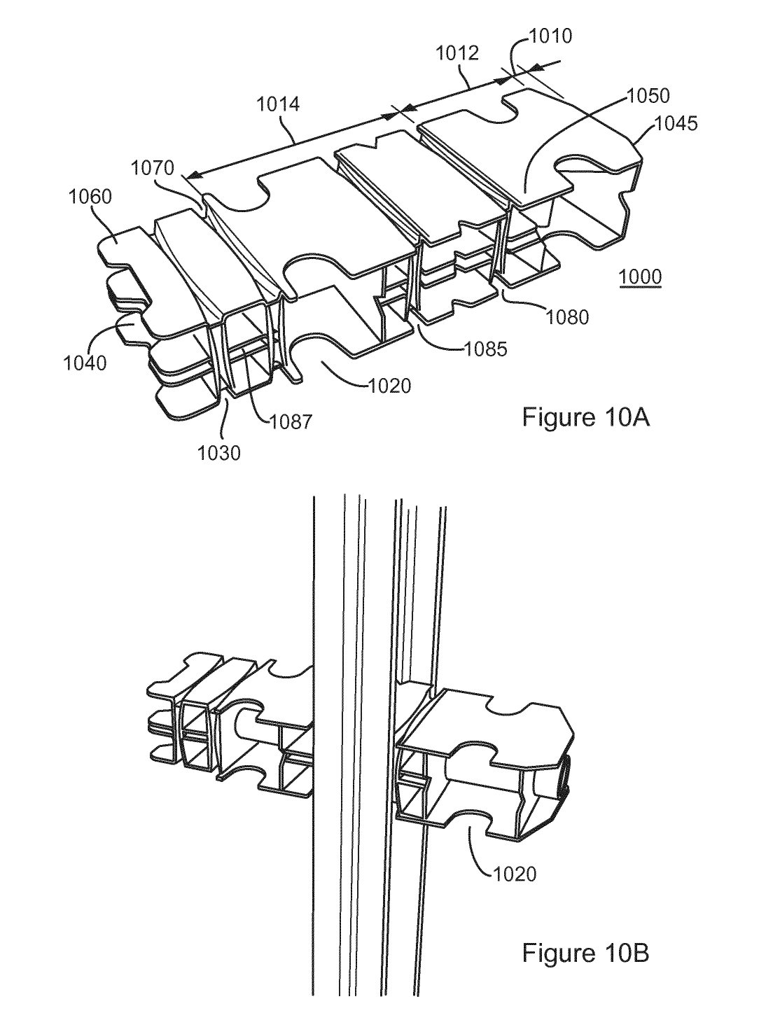

FIGS. 10A and 10B schematically illustrate a twist-type connector according to a fifth embodiment;

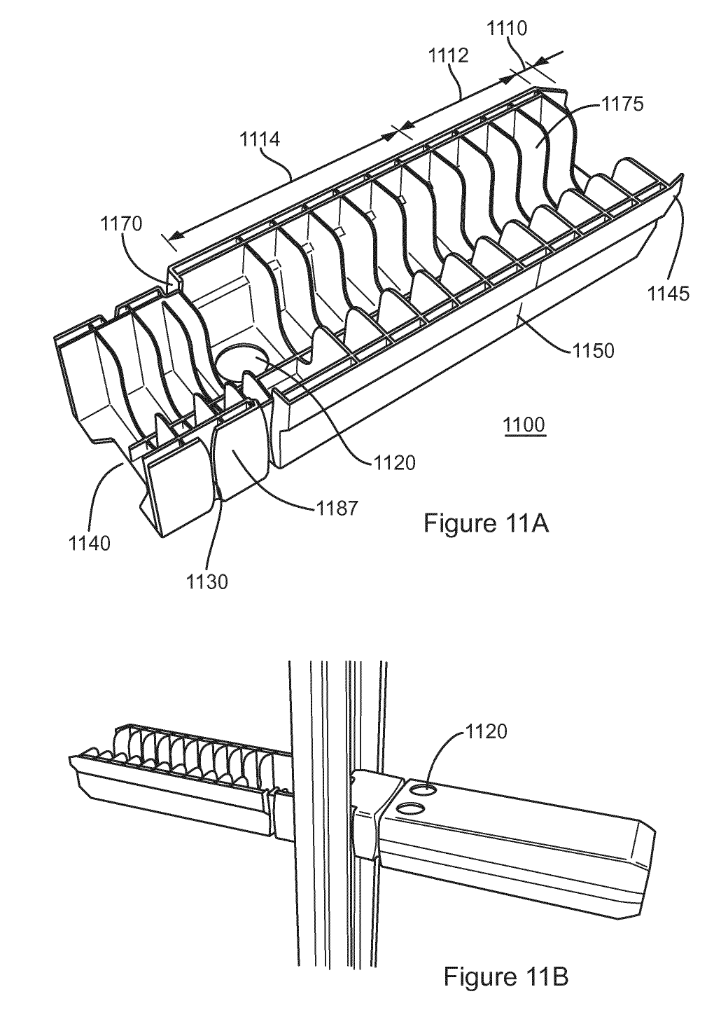

FIGS. 11A and 11B schematically illustrate a twist-type connector according to a sixth embodiment;

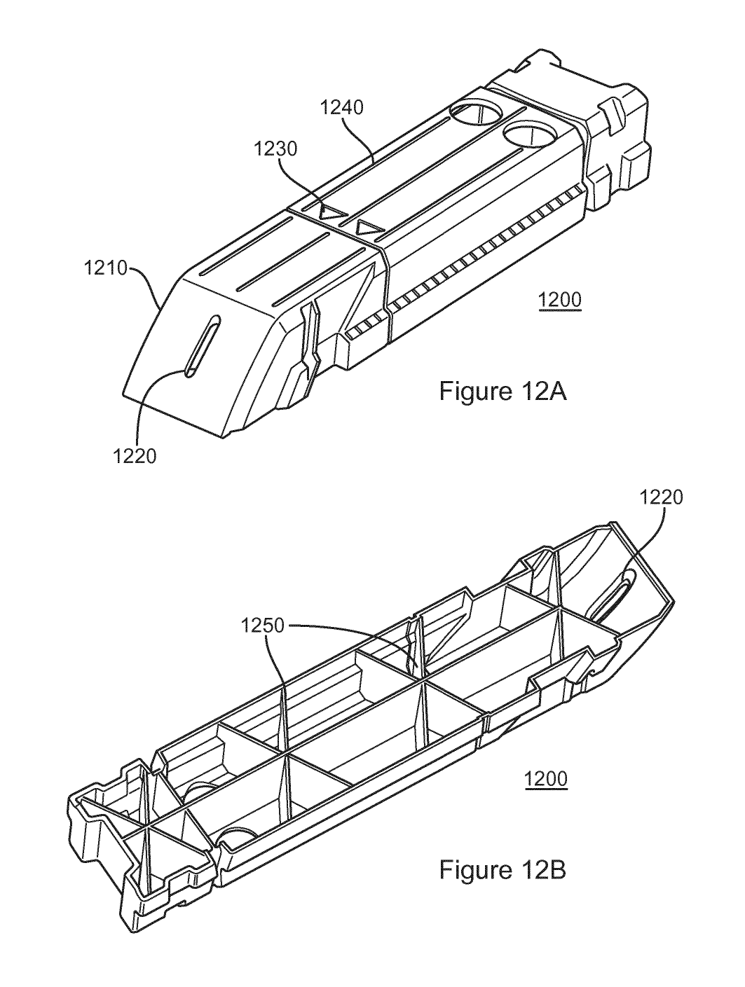

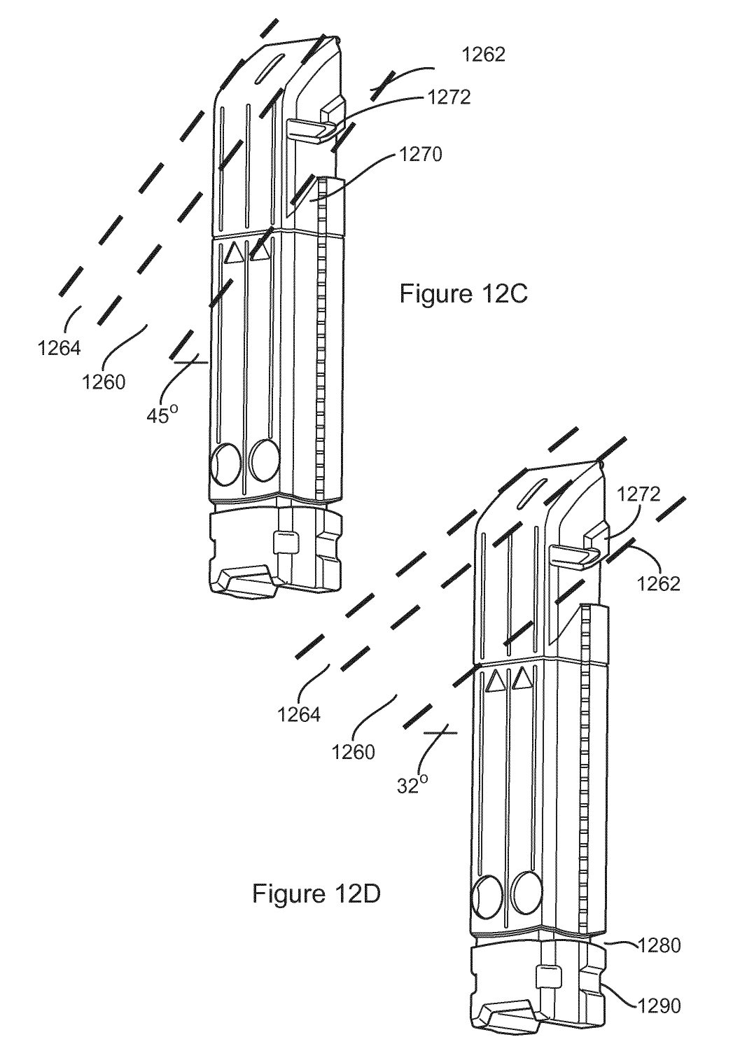

FIGS. 12A to 12D schematically illustrate a twist-type connector according to a seventh embodiment;

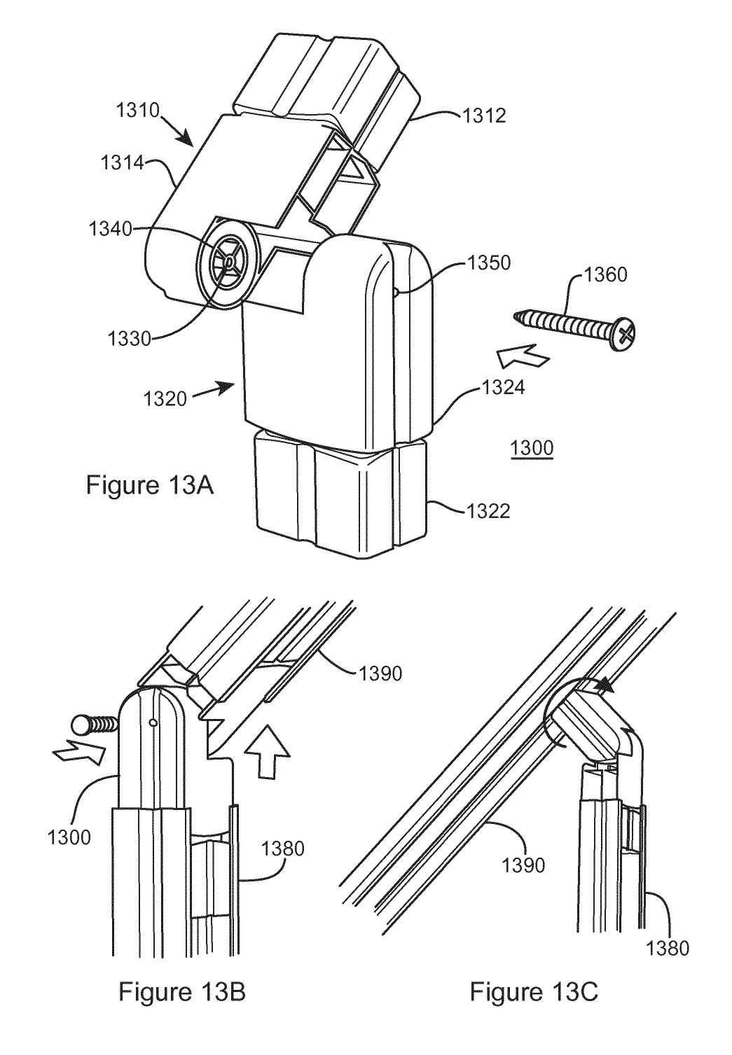

FIGS. 13A to 13C schematically illustrate a twist-type connector having first and second ends which are angled with respect to each other, to facilitate the construction of raked ceilings;

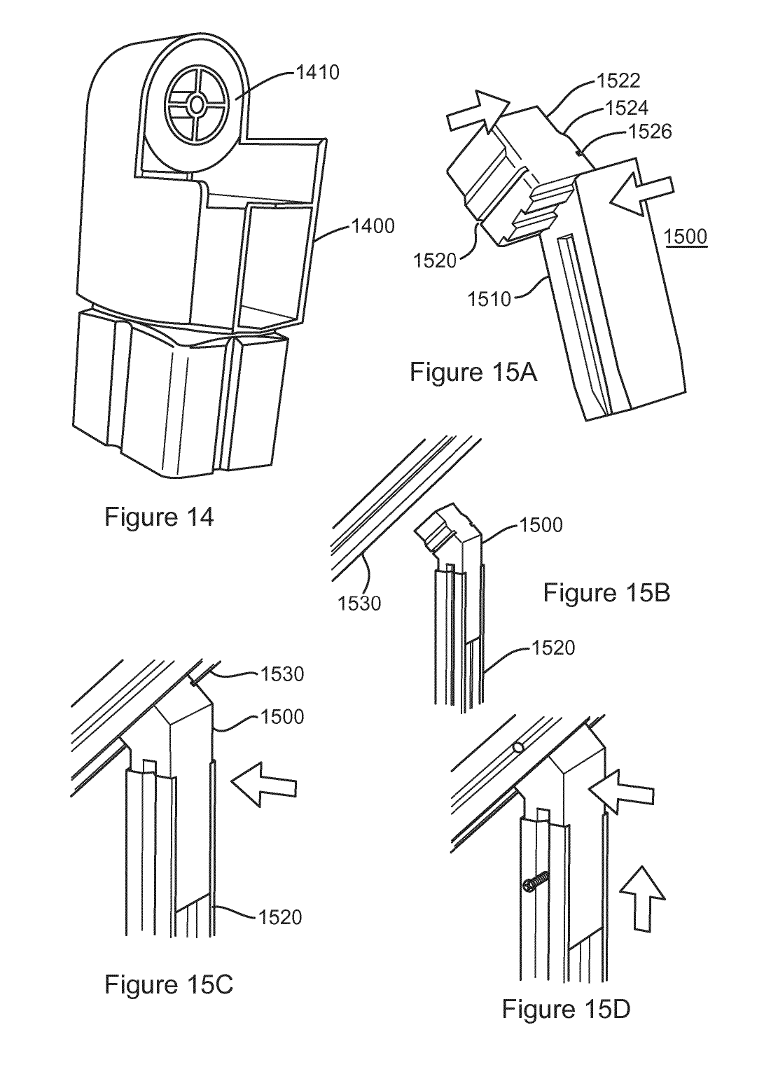

FIG. 14 schematically illustrates a variant of the twist-type connector of FIG. 13A;

FIGS. 15A to 15D schematically illustrate another twist-type connector having first and second ends which are angled with respect to each other;

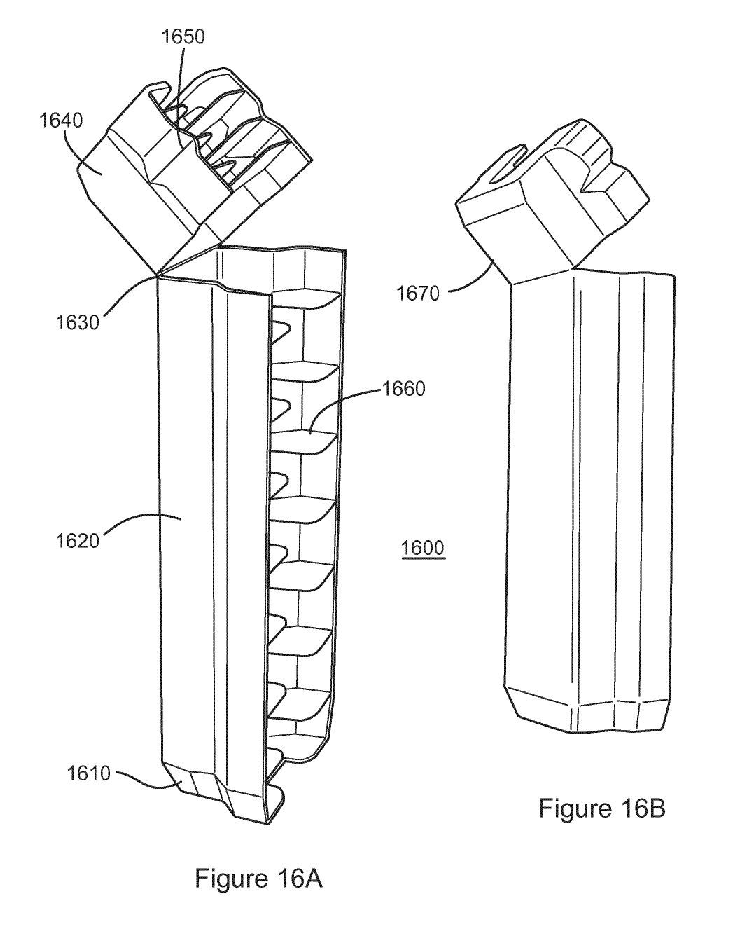

FIGS. 16A to 16C schematically illustrate another connector arrangement for handling raked-ceilings;

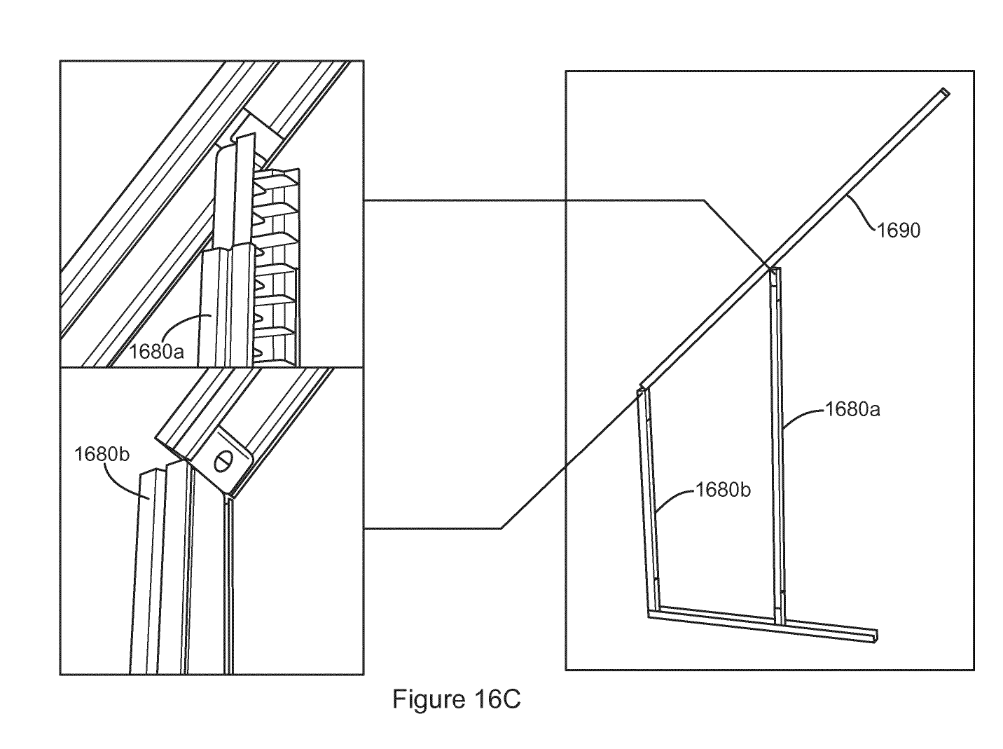

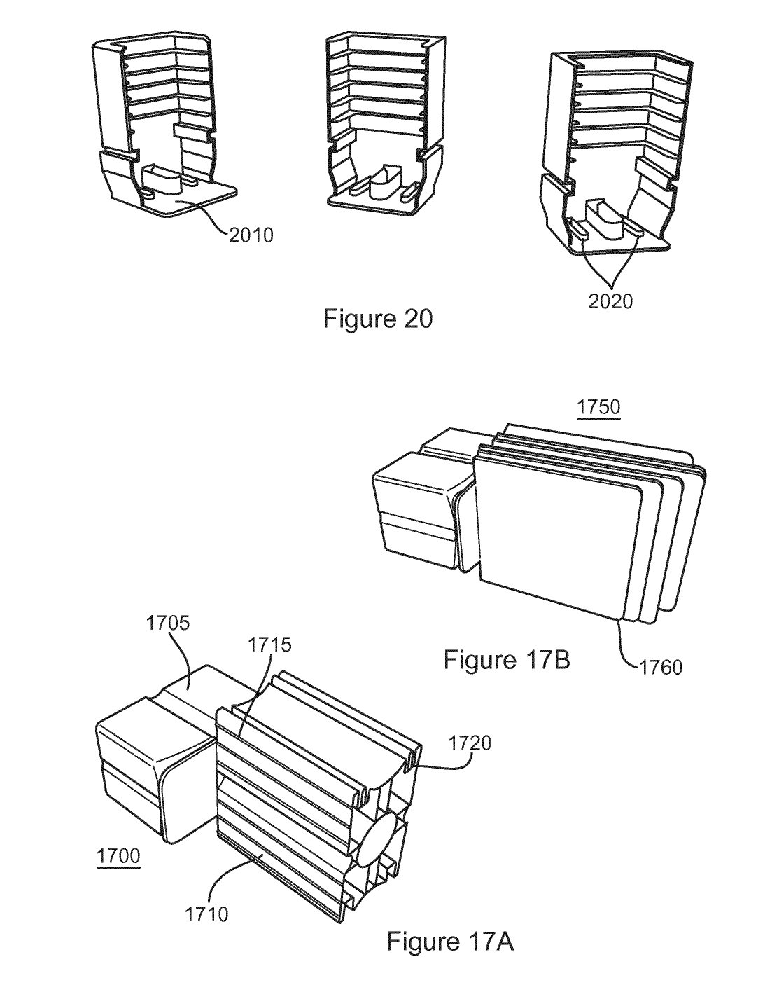

FIGS. 17A and 176 schematically illustrate twist-type connectors suitable for supporting a metal profile intended to bear a pattress;

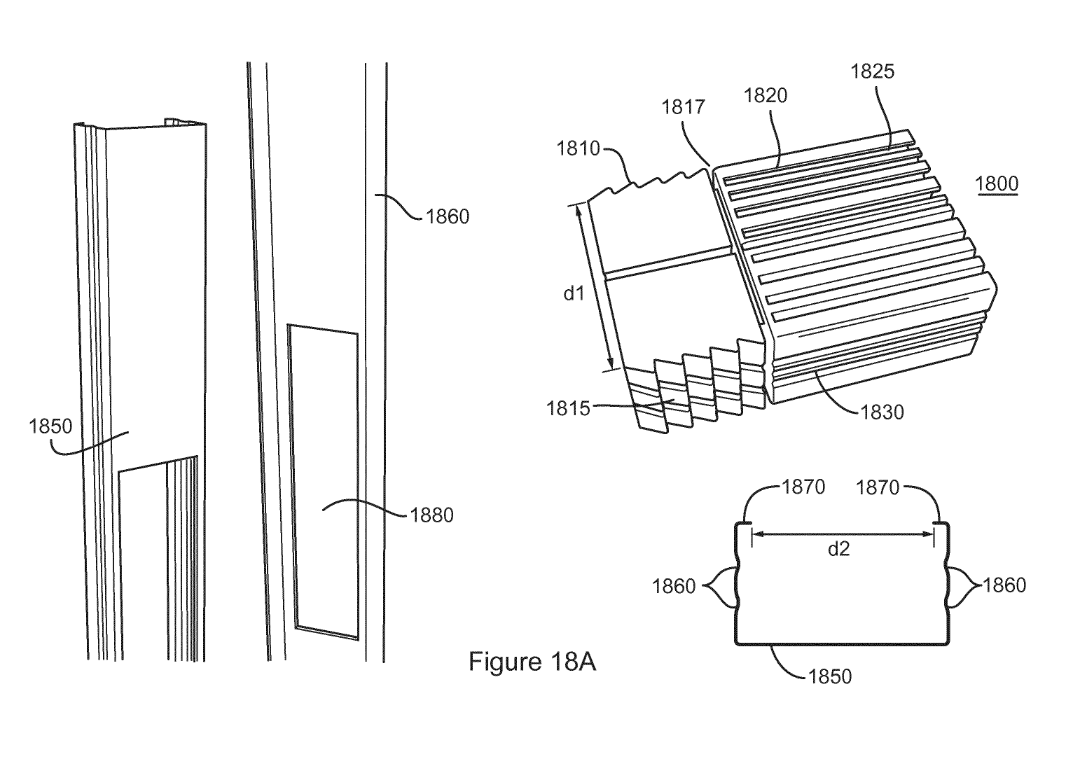

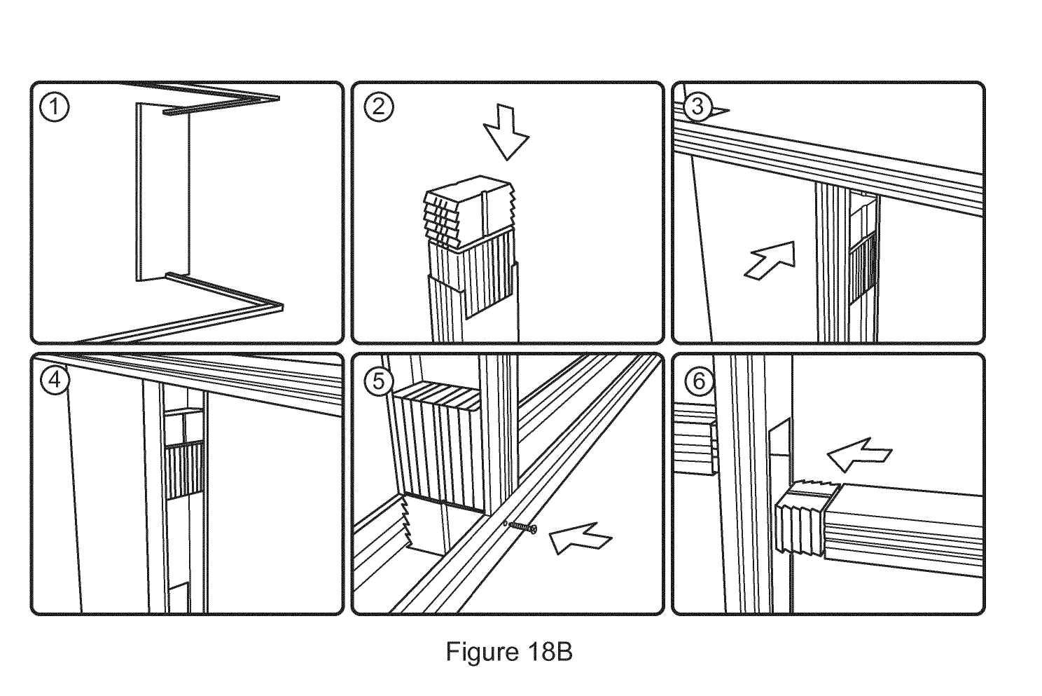

FIGS. 18A and 186 schematically illustrate a push-type connector according to an eighth embodiment;

FIGS. 1 9A and 196 schematically illustrate a push-type connector according to a ninth embodiment;

FIG. 20 schematically illustrates a push-type connector according to a tenth embodiment; and

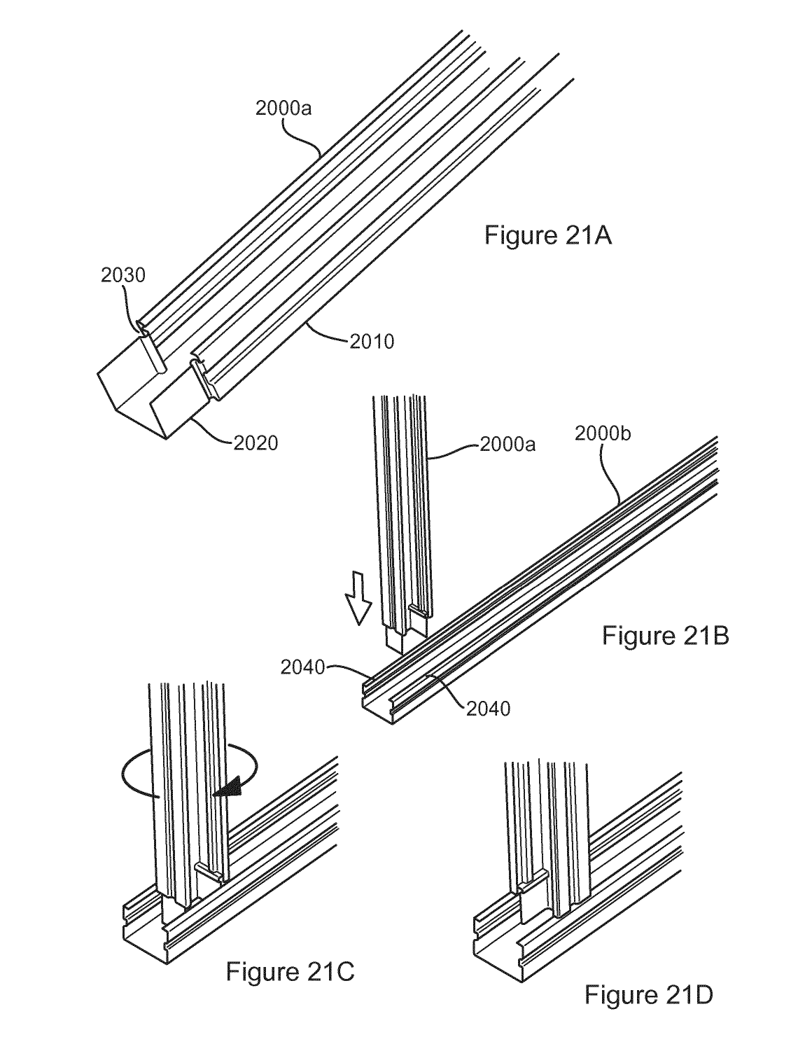

FIGS. 21A to 21D schematically illustrate a metal profile which can be twisted directly into locking engagement with another metal profile.

Referring to FIG. 1, a connector 1 is engaged within a channel 3 of a vertically disposed C shaped construction member 2. In order to achieve this, the cross section of the connector 1 has external dimensions which substantially match the internal dimensions of the channel 3. Drawing element 0 in FIG. 1 indicates a labelling convention for the various dimensions of the connector 1. The longest dimension of the connector, extending vertically in FIG. 1 is referred as the length, 1. The remaining dimensions relate to the cross section of the connector 1, and include the shortest (narrowest) cross sectional dimension wₑ and the longest (widest) cross sectional dimension W₂. The end portion of the connector 1 which engages within the channel 3 via its end is referred to as the first end portion. The channel 3 extends longitudinally of the C shaped construction member 2 from one end (the end into which the connector 1 is fitted in FIG. 1) to its other end. The engagement may be a relatively loose slideable engagement which permits the connector 1 and the C shaped channel 2 to move linearly with respect to each other (that is, such that the connector 1 is able to slide within the channel 3 of the member 2), for reasons which will be explained subsequently, or may instead be a relatively tight engagement. The C shaped member 2 comprises an opening 4 into the channel 3 which extends along one face (side) of the C shaped member 2. The side of the C shaped member 2 having the opening 4 also comprises lips (or rims) Sc and 5b which extend along the side of the opening 4 to retain the connector 1 within the channel 3. At the top of FIG. 1, a horizontally disposed C shaped construction member 6 is shown, having a channel 7 extending longitudinally through it. The construction member 6 comprises an opening 8 into the channel 7 which extends along one face (side) of the C shaped member 6. The side of the C shaped member 6 having the opening 8 also comprises lips 9a and 9b which extend along the side of the opening 8, It will be appreciated from FIG. 1 that the construction members 2 and 6 have the same profile (cross section). The connector 1 is able to join together two elongate members having the same profile (cross section).

The end portion of the connector 1 which is distal to the first end portion is referred to as the second end portion. The second end portion is provided with a groove 10 which extends (in this embodiment) around all four sides of the connector 1 at a predetermined distance from the (nearest) end of the connector 1. The groove 10 is provided with a gripping part 11 within the groove 10. The gripping part 11 is provided within one or both of the two wider sides of the connector 1. The purpose of the gripping part 11 will be explained subsequently.

The second end portion of the connector 1 is intended to engage with the construction member 6. In order to achieve this, the connector 1 is positioned at the entrance 8 to the channel 7 at a desired distance along the length of the construction member 6. The connector 1 is offered up to the channel 7 (directional arrow (A)) in a first rotational position with respect to the construction member 6 and the channel 7. The first rotational position is one in which the widest sides of the connector 1 (dimension w₂) are parallel with the edges of the opening 8, or in other words in which the narrowest dimension w₁ of the connector 1 is spanning between the edges of the opening 8. In this orientation the connector 1 is able to be inserted through the opening 8 and into the channel 7 of the member 6. It will be noted that the connector 1 as shown in FIG. 1 is not in the first rotational position. Once lifted up into the channel 7, the connector 1 is rotated (directional arrow (B)) clockwise with the groove 10 proximate the lips 9a and 9b. As the connector 1 rotates, the lips 9a and 9b will enter into the groove 10. The rotation will continue for 90° until the shorter edge (dimension WI) is parallel with the edges of the opening 8. This is the second rotational position of the connector 1 with respect to the member 6. It will be noted that the connector 1 as shown in FIG. 1 is in the second rotational position. In the second rotational position, the greatest cross sectional dimension W2 of the connector 1 is such that it extends across the opening 8 to substantially fill the width of the channel 7. It will be noticed that two of the square edges running along the length of the connector 1 are bevelled. These bevelled edges 12 permit the connector 1 to be rotated more easily within the channel 7. Without the bevelled edges, the greatest cross sectional dimension W2 of the connector 1 would have to be smaller in order to permit the connector 1 to rotate from the first rotational position into the second rotational position. In other words, the greatest cross sectional dimension W2 of the connector 1 can be a better fit to the width of the channel 7 when bevelled edges are used on at least two of the edges. As a result, more of the area of the lips 9a and 9b can be accommodated within the groove 10, providing for a stronger engagement between the connector 1 and the member 6. The insert locking mechanism works on the basis of a friction fit between the thin groove the edge profile of the metal section. Accordingly, bevelling all four edges is less desirable because it reduces the amount of contact between the slot and the lips.

It will be appreciated that the gripping part 11 does not engage with the lips 9a and 9b when the connector 1 is in the second rotational position. Instead, the gripping part is intended to permit the connector 1 to be engaged with the member 6 in the first rotational position. In order to achieve this, the connector 1 is positioned at the entrance 8 to the channel 7 at a desired distance along the length of the construction member 6, and is offered up into the channel 7 (directional arrow (A)) in the first rotational position with respect to the construction member 6 and the channel 7. However, instead of rotating the connector 1 within the channel, the groove 10 is aligned with one of the lips 9a and 9b and pressed onto it such that the gripping part 11 within the groove 10 engages with the lip. It will be understood that a connector engaged with the lip 9a of the member 6 in this way will be set back from a front part 13 of the member 6 compared with a connector 1 which is rotationally engaged with the member 6. As a result, a member 2 engaged with the first end portion of a connector 1 engaged only with the lip 9a using the gripping part 11 will be set back with respect to a member 2 engaged with the first end portion of a connector 1 (rotationally) engaged with both the lips 9a and 9b. This is particularly useful where a patress is to be set back within a wall structure, since the patress can be fixed to a vertical or (usually) horizontal member which is set back with respect to other members by way of the gripping part.

In either engagement with the member 6 using the second end portion of the connector 1, the sliding engagement of the first end portion of the connector 1 permits the member 2 to slide up and down (directional arrow (C)) with respect to the connector 1 (which is itself locked into place to the member 6). It will be appreciated (and explained further below) that the connector 1 can be used to join vertical studs to ceiling and floor (horizontal) channels. The sliding engagement may be able to absorb head deflection where the ceiling channel deforms with respect to the floor channel following installation of the stud. In addition, the slideable engagement reduces the need for the member 2 to be cut accurately to length, because length adjustment can be achieved with the connector 1. Moreover, the member 2 can be cut shorter than would conventionally be the case, since part of the distance to be spanned is bridged by the connector itself.

It will be appreciated that the sliding engagement may instead be with a horizontal member and the twisting engagement with a vertical member. Alternatively, both members may be horizontal in the case where a ceiling or floor structure is being formed, or one or both of the members may even be in an angled orientation such as might be required in the construction of a pitched roof. However, in all these cases it will be appreciated that the connection formed between the two members is a right angle connection. In principle however, the invention might be used to form a non-right angle connection in a case where the first end portion (slide fit) and second end portion (twist fit) are not at either and of a purely linear structure but are instead at either end of a curved or angled structure.

Referring now to FIG. 2, a connector 101, which is similar to the connector 10, is schematically illustrated. However, the connector 101 uses a slot 110 and notch 112 along the narrowest sides (the arrow 130 indicates that the slot and notch structure is repeated around the other side, although the notch will be facing in the other direction to achieve rotational symmetry) instead of a groove as is used in FIG. 1. The slot 110 is intended to receive lips 109a and 109b of a member 106 (which may be a channel or a stud for example) when the connector 1 is raised up into a channel 107 and twisted clockwise from a first rotational position (in which the cross section of the connector 101 will fit through an opening 108 into the channel 107) to a second rotational position (in which the cross section of the connector 101 is oriented such that it cannot be extracted from the channel). The slot 110 binds onto the profile edge (lips 109a and 109b) in the twisted position. The notch 112 serves to guide the lips 109a and 109b into the slot 110, and therefore permits the connector 101 to be less accurately aligned with the lips 109a and 109b when the connector 101 is first rotated. The configuration shown in FIG. 2 is for clockwise rotation. For an anticlockwise rotation the notches 112 would be provided at the other end of each slot 110. As with the FIG. 1 embodiment, the connector 101 is slideably engageable at its first end portion through the end of a member 102, to allow for the member 102 to be cut shorter and less accurately, and to allow for head deflection.

Referring to FIG. 3, a connector 201 is schematically illustrated. The connector 201 is again slideably engaged with a member 202, and can be rotationally brought into firm engagement with a member 206. The members 202 and 206 may be channels, studs or noggins for example. Similarly to FIG. 2, the connector 201 uses a slot 210 and notch 212 along the narrowest sides to engage with lips 209a and 209b of the member 206 when the connector 201 is raised up into a channel 207 and twisted clockwise from a first rotational position (in which the cross section of the connector 201 will fit through an opening into the channel 207) to a second rotational position (in which the cross section of the connector 201 is oriented such that it cannot be extracted from the channel). As with FIG. 2, the connector 201 is slideably engageable at its first end portion through the end of a member 202, to allow for the member 202 to be cut shorter and less accurately, and to allow for head deflection. The members 202 and 206 are much deeper than the equivalent members in FIGS. 1 and 2, and include alignment guides 260. As a result, the second portion of the connector 201 comprises a curved inset 214 to engage with the alignment guides 260, thereby providing an improved engagement. It will be appreciated that any of the connectors described above may be hollow, or provided with a channel extending from the first end portion to the second end portion to permit electrical wiring and/or pipes to be passed through the members and through the joins between the members (via the connector). Conveying pipework through a channel or cavity in the connector may advantageously prevent or at least reduce the rattling noise which can be caused by movement of pipes against surrounding structures. FIG. 5 provides an example of a connector with apertures for permitting pipes and cables to pass through it.

In all of the above embodiments, the groove or slot and notch structure can optionally be repeated at the other end (first end portion) of the connector. In this way, either end of the connector can be used as the first end portion (for slideable engagement via the end of a member) and as the second end portion (for twisting engagement within the channel of a member).

Referring to FIG. 4, a stud wall with a doorway is schematically illustrated. The stud wall is constructed using a ceiling channel 320, floor channels 321 and 322, vertical studs 323, 324, 325, 326, 327 and 328, door head 329, noggins 330 and 331, and connectors 301, 302, 303, 304, 305, 306, 307, 308, 309, 310, 311, 312, 313, 314, 315, 316, 317 and 318. All of the ceiling channel, floor channels, studs, door head and noggins are metal members having the same C-shaped profile (cross section) as each other. They can therefore all be manufactured from the same materials. The connectors are also all the same as each other. The stud wall can therefore be constructed using only two fundamental source materials. The joins are all achieved using the connectors, and so in principle the only required tools to construct the frame of the wall are a pair of snips (for cutting channels to length).

The stud wall is constructed by first screwing the ceiling channel 320 and the floor channels 321 and 322 into place on the ceiling and floor respectively. Then, the vertical studs 323, 324, 325, 326, 327 and 328 are (if necessary) cut to an appropriate length (which will be less than the distance from ceiling channel to floor channel because as described above the connectors will span some of this distance). However, in general it will not be necessary to cut the channels on site, because they can be manufactured or cut off site to a set dimension, with any on site deviations from the set dimension being taken up by the tolerance provided by the sliding relationship between connector and channel. A connector 301 is slid into one end of the stud 323 and a connector 313 is slid into its other end. Depending on how tight the engagement is it may be necessary to use a hammer or mallet to force the connectors 301 and 313 into the ends of the stud 323, but preferably the tightness of the engagement should be such that the connectors 301 and 303 can be urged by hand into the ends of the stud 323. Then, the stud 323 is positioned in vertical alignment with the connector 301 raised into the channel of the ceiling channel 320 and the connector 313 placed into the channel of the floor channel 321. The stud 323 is then rotated to lock the connector 301 into the channel of the ceiling channel 320 and the connector 313 into the channel of the floor channel 321. Minor adjustments to the horizontal position of the connectors within the ceiling channel 320 and floor channel 321 can then be achieved by tapping against the connectors until the stud 323 is positioned vertically, and in the right position.

The same process is then conducted in relation to the studs 324, 325, 326, 327 and 328 using the connectors shown. As explained above, the slideable connection is desirable for various reasons, and its benefit continues following installation by allowing for deflection of the ceiling channel. However, if it is considered undesirable for both the top and bottom connectors to be in sliding engagement with the stud, then the stud could be fixed (for example with screws) to one of the connectors, while still providing for deflection.

The door head member 329 can then be fitted by cutting a section of the C-shaped profile to length, sliding the connectors 307 and 308 into each end, placing the door head member 329 between the studs 325 and 326 at the desired height, and rotating the door head member 329 to engage the connectors 307 and 308 with the channels of the studs 325 and 326. It will be appreciated that, since only one side of each stud is provided with an opening along the length of the channel, the stud 326 will need to be accessed via a cut out in the rear of the stud (see FIG. 6 for further details), so that the door head member 329 is able to engage with the channels of both studs. Once twisted into place, minor adjustments can be made by tapping the connector and/or door head member 329 by hand to manoeuvre it into position.

The noggins 330 and 331 can be installed in a similar manner to the door head member 329. However, both of these noggins are required to engage with the stud 324. This causes a problem because the channel is only open along its length on one side. This problem is addressed in the same way as for the door head member 329 by providing cut outs in the side of the C-shaped profile opposite to the opening. The cut out may have the same width across the member as the width of the opening on the opposite side (to permit the connector to pass through it when in the first rotational position) and extends a sufficient distance along the member to allow the second end portion of the connector to be inserted when in the first rotational position. In practice, the width of the cut out may be slightly different from the width of the opening to the channel, provided that the groove (or other engagement structure) of the connector is suitably dimensioned to be able to handle both widths. In practice, for manufacturing reasons (of the channel), it may be preferable for the cut outs to be a few mm narrower than the opening. From the above, it will be appreciated that embodiments of the present invention provide a single piece connector, which allows metal profiles to be joined together without the need for screw fixing or crimping. This allows a profile of single design to be used throughout the system, removing the need for channels that are different to studs. The connector slides into the end of the vertical profile, and once inserted the vertical profile can be twisted and locked in place top and bottom into the head/base profile (ceiling and floor channel).

The connector can be inserted within the stud (vertical member) to allow it to be extended when required. There is a groove/slot at the top end of the connector block which can be fitted and consequently locked into the receiving channel of the horizontal channel. The telescopic projection allows the installer to be able to connect a stud and channel without the need cut the studs to length.

Referring now to FIG. 5, a connector 400 having openings for permitting the passage of cables and/or pipes through it is shown. In particular, the connector 400 has an end hole 410 which is an opening into a through bore which extends along the length of the connector 400 to a similar opening (not shown) at the opposite end of the connector 400. This permits a cable or pipe to pass through the full length of the connector 400. The connector 400 also comprises a series of side holes 420, each of which are openings into through bores which extend fully through the width of the connector 400 to corresponding openings (not shown) at the opposite side of the connector 400. It will be appreciated that the through bore from the end hole 410 intercepts the through bores from the side holes 420, permitting an electric cable for example to enter into an end hole and exit via a side hole (or vice versa). Also visible on the connector 400 is a serrated formation 430 on a side of the connector intended to be in contact with a C-shaped member 450. A serrated formation is also present on the opposite side face of the connector 400 (not visible in FIG. 5). The serrated formations of the connector 400 are intended to engage with serrated formations on the inside side walls 460 of the member 450. It will be appreciated that the serrations could be provided only on one inside side wall of the member 450, or on both inside side walls of the member 450. The mutual engagement between the serrations of the member and the connector facilitates control of the sliding movement between the member and the connector.

Referring now to FIG. 6, a C-shaped member 500 having cut-outs, or slots, for permitting a connector to access the channel within the C-shaped member 500 is shown. The cut-outs are intended to allow the connector as described above to be inserted through a cut-out and into the channel, and then rotated into a locking engagement in a similar manner as if it had been inserted into the open face of the member 500 and rotated into a locking engagement. In the non-limiting example of FIG. 6, the member 500 is a vertical stud, and three cut-outs are shown—one each at the top and bottom, and one at the middle. The overall length of the channel 500 is a, which is preferably approximately 2300 mm, and is an appropriate length to run from floor to ceiling in a building of conventional construction when connected between floor and ceiling channels using the connectors described above. A top cut-out 510 is at a position on the member 500 (distance b from the most distant end of the member 500, b preferably being approximately 1900 mm-1917 mm in this example) to be at the right height (when the member 500 is installed) to permit a door head member 540 to be installed between the member 500 and an adjacent vertical stud, where the two adjacent studs are fitted with their open sides facing in the same direction. A bottom cut-out 520 is at a position on the member 500 (distance c from the nearest end of the channel 500, c preferably being approximately 400 mm-383 mm in this example) to be at the right height (when the member 500 is installed) to permit a horizontal patress supporting member to be installed between the member 500 and an adjacent vertical stud. A patress for an electrical socket 550 can then be installed to the patress supporting member.

A middle cut-out 530 is at a mid-point of the member 500, at a position d which is approximately 1150 mm from each end. The height of the middle cut-out, when the member 500 is installed vertically, is appropriate for installing a horizontal patress supporting member for a light switch patress 560, or for supporting a noggin between the member 500 and an adjacent vertical stud. Preferably, the distance from one end of the member 500 to the bottom cut-out 520 is the same as a distance from the other end of the member 500 to the top cut-out 510. This, combined with the centre point position of the middle cut-out 530 provides a symmetrical member which can be installed either way up, which is convenient for installation purposes. The length e of each of the cut-outs is preferably approximately 200 mm, providing sufficient tolerance for each of the top, middle and bottom cut-outs to be used for a door head, light switch/noggin and power socket respectively, whichever way up the member 500 is installed. The length of the cut-out may also be sufficient to receive two connectors, which may be required in the case of noggins being provided to either side of the same stud—for example the noggins 330 and 331 in FIG. 4. The length and positions of the cut-outs enables the original lengths of material from which the 2300 mm studs are cut to be provided with cut-outs at regular intervals along its length before trimming to 2300 mm. This results in a simpler manufacturing process. It also permits the stud to be used either way up.

A large number of advantages can be achieved by way of the above:
A single metal profile can be used to act as stud, channel, noggin and door head, and optionally to support a patress.
A single component of one design can form all the connections required.
The C-shaped metal profile is “safe” as it has folded edges (less chance of injury if someone falls onto the open side of the profile, and generally easier to handle during installation). The metal profile is also easier to interact with once installed—if a user reaches into the partition the use of folded edges means that there are no sharp edges to be cut on.
Reduced need to cut studs to height or noggins to length accurately, and could also save material by deliberately supplying them “short”.
Allows for improved deflection at the head (when compared to conventional systems).
Provides a deeper head channel than conventional systems, enabling ceiling boards to be fixed before wall boards if required. In particular, with the shallower ceiling channels conventionally used, should the ceiling be boarded prior to the stud wall, most of the depth of the ceiling channel will have been lost to the ceiling, leaving little of the ceiling channel to fix the boards of the stud wall to. By providing a deeper channel, the ceiling can be boarded before the stud wall, while still leaving enough of the ceiling channel to fix to.
Provides a flatter surface for board fixing over the whole area—no bumps due to wafer-head screws being screwed through from the outside of a ceiling or floor channel (for example) into a wooden stud placed within the channel, nor an overlap of channel over studs (because unlike in conventional systems all members (i.e. the floor/ceiling channels, stud channels and noggin channels) have the same dimension and thus provide a uniform front face to which boards can be fixed). It will be appreciated that in conventional systems, the bumps and non-flush surfaces can make it more difficult to fix plasterboards to the stud wall, and result in bowed plasterboard surfaces. The same principle of a flush finish applies for a door frame created in a studwork wall using these techniques.
An additional connector can be inserted into the channel to provide a strong point to fix to (by pushing it further down the stud) at mid-height e.g. for door frames.
Enables reduction in tooling requirements for framed construction (just snips) once channels are fitted.
The studs remain adjustable but secure (will not fall) right up until boards are fixed to them, without temporary fixing/crimping etc.
The use of the connector in a noggin stiffens the adjacent studs because the connector “fills” the channel of the stud, resulting in less chance of board stepping due to the C-profile of the stud twisting under pressure from screw-gun (an “empty” channel of a stud can cause the edge of the profile near to the channel opening to deform more than the edge of the profile away from the channel opening).
The connector could be used to join studs end-to-end for greater height (turn short studs/members into longer ones).
The connector would eliminate or at least reduce the issue of studs rubbing against channels when the frame moves (a current symptom of poor fixing installation which leads to metal on metal noises), since the connector does not need to be formed of metal.
The connector has a screw fixing capability where required for practical detailing.
Noggins and patrassing can be installed by one person, and then easily adjusted as necessary by the service installer-plumber/electrician (is a complete system).
The use of a single metal profile acting as stud, channel and noggin minimises waste and avoids the possibility of distributor confusion between a range of profiles.
The connector could replace the need for metal to metal drywall screws, as well as the need for metal cutting equipment on site.

Referring to FIG. 7A, a C shaped construction member 700 having a modified cross section is shown. The modified cross section extends along substantially the whole length of the member in this case, although in alternative embodiments the modified cross section may only be present in regions which could be expected to engage with a connector. Referring to FIG. 7B, which illustrates the cross section only, it can be seen that the constructions member or channel 700 (like the construction members described previously) comprises a floor 705, side walls 710a, 710b and a substantially open face opposite to the floor 705. The substantially open face comprises an aperture 720 which extends along (usually) the entire length of the member, and which provides access to the interior of the channel. The substantially open face comprises lips 725a, 725b which extend along each side of the aperture, with which engaging parts of a connector may engage, as described above. As described above, the floor 705 may be provided with apertures at certain positions along the length of the member to permit connectors to engage with the channel from the opposite direction. In FIG. 7B, each side wall 710a, 710b comprises a groove 715a, 715b. As can be seen in FIG. 7C, the grooves 715a, 715b are shaped and dimensioned to accept the head of a standard drywall screw 730. The increased size of the grooves 715a, 715b also serves to provide improved engagement with the first end of a connector 735 slideably inserted into the channel. In particular, the grooves 715a, 715b, having a concave form at the outside of the member 700 (to receive the head of the screw), has a convex form at the inside of the member 700, which engages with a groove 740 formed in the connector 735. Moreover, the groove 740 permits the grooves 715a, 715b to have the depth required to receive the screw 730. As can be seen in FIG. 7C, the connector 700 may have a hollow design, enabling cables to pass through the connector, making the connector lighter and cheaper (reduced materials cost) and making it easier for the screw 730 to penetrate fully into the connector 735. It will be appreciated that the head of the screw 730 may protrude slightly above the groove, or may be flush (which would require the grooves 715a, 715b to be wider and/or deeper). The connector 735 is also provided with crush ribs 750 which extend (in this case) longitudinally of the connector, and which provide improved engagement with the inside of the channel. It will be appreciated that the crush ribs 750 may have other orientations (laterally, or diagonally for example), and may be pips or textured surfaces rather than ribs.

Referring to FIG. 8A, a connector 830 corresponding to the connector 730 of FIG. 7, is shown in detail. Screw mounting grooves 840 are shown to extend longitudinally of both ends of the connector (the first end, to the right hand side of FIG. 8A, to be slid in through an end of the C-shaped channel, and the second end, to the left had side of FIG. 8A, to be inserted through the opening of another channel, and then rotated into locking engagement). The first end of the connector has a chamfered end 845 to aid its insertion into the end of a channel. The first end of the connector is also provided with crush ribs 850, which as explained in relation to FIG. 7A provide for increased frictional engagement with the interior of the channel. More particularly, the crush ribs 850 are crushed (although not necessarily deformed) between the main body of the connector 835 and the inside surface of the channel. The second end of the connector has smaller cross sectional dimensions than the first end, so as to aid its insertion through the opening in the channel (when oriented with its longer cross sectional dimension parallel to the longitudinal axis of the channel) and to aid its rotation into a second orientation in which its longer cross sectional dimension extends across the width of the channel. In the connector 830, a groove 855 extends around the circumference of the connector 830, and separates the first and second ends. The groove 855 has ramped faces at each of its four corners, on both sides of the groove (first end side, and second end side), to create a cam action to tighten the connector during the twisting action. The relatively wide corner parts of the groove are easy to line up with the lip of the channel, and guide the lip into the narrower central part of the groove on each of the two smaller (side) faces of the connector 830. The lip will be located (and preferably gripped) within the groove, while the two smaller faces of the second end of the connector will be trapped between the internally projecting (convex) parts of grooves 815a, 815b on the side walls of the channel. In this way, the connector 830 is secured into the channel when in its second rotational position. Referring to FIG. 8B, a C-shaped channel 860 is shown, and can be seen to have a hole/slot 875 cut into the rear of the channel to allow fitting of pattresses/noggins in either orientation (i.e. so that the second end of the connector can be fitted through the hole 875 rather than through the main aperture). The channel 860 can also be seen to have a groove (outside of channel)/ridge 815 (inside of channel) running along its side wall. The internal (ridge) part may be a pressed side joggle which increases the strength and rigidity of the channel, while allowing (substantially) flush fitting of countersunk screw heads as discussed above. Referring to FIG. 8C, a method of installing studs using the connector and channel described in FIGS. 8A and 8B is illustrated. The method is shown as comprising six numbered steps. In the first step, the floor plan is laid out using channel sections for the ceiling and floor. In the second step, a connector is slid into a channel in the direction of the arrow to form a stud, with the connector projecting from the end of the channel. This is repeated at the other end of the channel, so that a connector projects from each end. In the third step, the parts of the two connectors projecting from the ends of the channel are inserted between the lips of the floor channel and ceiling channel respectively, and then rotated as shown by the arrow until locked into place top and bottom. In the fourth step, pattresses or noggins can be created by the same method, if required. This involves the repetition of the second step to form a pattress or noggin, and the repetition of the third step between two adjacent studs—noting that it may be necessary to insert the connector through the hole rather than the main aperture (as shown in the fourth step diagram). In the fifth step, the studwork can be secured with screws into the connector, with the heads of the screws being received in the grooves in the outside of the channel, to provide a relatively flush finish. Finally, in the sixth step, cables can be routed through channels in the connector, as required.

Referring to FIG. 9A, a modified connector 900 is shown. The first end of the connector 900, on the right hand side of FIG. 9A, can be considered to have three main parts, these being a 10 mm (for example) lead in part 910 with a chamfered end 945 to facilitate insertion of the first end into the end of a channel (which may be particularly problematic when inserting the connector into a ragged hand-cut section of channel), a 50 mm (for example) minimum insertion part 912, and an 85 mm (for example) extension part. A minimum insertion mark 950 is visible on the connector 900. In order to provide a sufficiently strong joint, the connector 900 should be inserted into the end of a channel at least up to the minimum insertion mark 950, such that the lead in part 910 and the minimum insertion part 912 are completely inserted into the channel. Some or all of the extension part 914 may also be received in the end of the channel, depending on the length of the channel, and the area to be bridged by the channel and connectors in combination. The extension part 914 also has a cutout 920 (on each side) to accept piping and electrical cabling—either vertically when being used in noggin mode, or horizontally near the floor or ceiling when being used in stud mode. The second end of the connector comprises a chamfered leading edge 960, to enable the second end to be inserted into the open side of the channel more easily. The second end of the connector also comprises a cutout or hollow region on its end face 940, so that the connector is kept clear of any screwheads in the channel (which may be present in the desired locations for studs where the floor and ceiling channel has been screwed to the floor/ceiling). The second end of the connector comprises grooves for engaging with the lip of the channel at two distances from the leading edge of the second end of the connector, a first of the grooves 970 being substantially twice the distance from the leading edge of the connector than the second of the grooves 930. The first groove 970 is intended to engage the lip when the connecter is inserted fully into the channel (so that the leading edge contacts or is immediately adjacent to the base of the channel), while the second groove is a ramped cutout which allows the fitting of one connector through the open side of the channel, and another connector through a hole in the base of the channel. The first groove 970 extends all the way around the connector, and has ramped faces to create a cam action to tighten the connector onto the channel by way of the twisting action. In contrast, the groove 930 is provided only in the two short opposing faces of the connector. The presence of grooves at these two different distances from the leading edge of the connector make it possible to provide equal height horizontal noggins—since each connector only penetrates half way into the channel, the leading edges of the two connectors meeting (or almost meeting) in the middle. This is illustrated in FIG. 9B, where two identical connectors 900a, 900b are locked in to the same channel 990 at the same position along its length. In the present case the upright channel is a stud, and the two opposing connectors are intended to support level horizontal noggins. Also apparent in FIG. 9B are the cutouts 920 which allow piping and cabling to be tracked downwards.

A problem with the connector of FIG. 9A is that it requires a complex four-way split on the injection moulding tool with two sliding core sections. This may be achievable, but will increase the mould cost, moulding cycle time, and part cost. Referring to FIG. 10A, an alternative connector 1000 is shown which requires a more simple open and shut injection mould tool with a sliding core. The mould cost, cycle time and parts cost could therefore be reduced compared with the FIG. 9 variant. While the connector of FIG. 10A looks very different from that of FIG. 9, many of the features are the same. In particular, features 1010, 1012, 1014, 1070, 1040, 1020, 1050 and 1045 correspond to features 910, 912, 914, 970, 940, 920, 950 and 945 respectively, and will not be described again. However, some parts differ. For example, the leading edge 1060 of the second end (left hand side of FIG. 10A) has a radiused leading edge for ease of fit rather than a chamfered leading edge 960 as for FIG. 9. Further, the second groove 1030 extends completely around the connector rather than only being present on two sides, and is also formed with the same structure, or a very similar structure as that of the first groove 1070. The connector 1000 also comprises additional third and fourth grooves 1080 and 1085 respectively, again having substantially the same structure as the first groove 1070. The third and fourth grooves each having ramped faces, and together allow the connector to extend all the way through a channel—extending through both the open face of the channel, and also the cutout, in the manner shown in FIG. 10B. In other words, the third groove 1080 will engage with one of the edges of the cutout in the base of the channel and the lips extending along the open side of the channel, and the fourth groove 1085 will engage with the other of the edges of the cutout in the base of the channel and the lips extending along the open side of the channel. It will be appreciated that this requires the separation between the third and fourth grooves to be substantially equal to the thickness of the channel from the base (the face in which a cutout is made) to the open face. The benefit of this arrangement is that a single connector can be mounted horizontally through a cutout in an upright stud channel to allow noggins to be fitted level (the noggins will be mounted onto the parts of the connector projecting out from each side). It will be appreciated that both ends of the connector are dimensioned to be slidable into an end of a channel. Also apparent in FIG. 10B are the cutouts 1020 which allow piping and cabling to be tracked downwards. Returning to FIG. 10A, dual ribs 1087 are provided to accept drywalling screws. This compensates for the reduction in material to screw into, when compared with the FIG. 9 variant.

Referring to FIG. 11A, an alternative connector 1100 is shown which requires a more simple open and shut injection mould tool. The mould cost, cycle time and parts cost could be reduced compared with both the FIG. 9 variant and the FIG. 10 variant. While the connector of FIG. 11A looks very different from that of FIG. 9 (or FIG. 10), many of the features are the same. In particular, features 1110, 1112, 1114, 1140, 1120, 1150 and 1145 correspond to features 910, 912, 914, 940, 920, 950 and 945 respectively, and will not be described again. However, some parts differ. For example, the cutouts 1120 extend as bores through the connector. Further, while like FIG. 10 dual ribs 1187 are provided, in the case of FIG. 11A these form the edges of the connector, rather than extending longitudinally along the centre of the connector in the case of FIG. 10A. In the connector of FIG. 11A, lateral ribs 1175 are also provided, to strengthen the connector. Like the connector 900, the connector 1100 has grooves at two positions from the leading edge of the second end, permitting two connectors to be mounted adjacent each other to form a level noggin. This is illustrated in FIG. 11 B. It will be appreciated that the first ends of the two connectors (the ends projecting outwardly from the upright channel) can be inserted into the end of a channel for a noggin either way up (both orientations are shown in FIG. 11 B).

Referring to FIGS. 12A to 12D, a variant of the connector of FIG. 11 is schematically illustrated. FIG. 12A shows the upper surfaces of a connector 1200, while FIG. 12B shows the underside of the connector 1200. The elements of the connector 1200 also present in FIG. 11A are not described again here, but are apparent from the drawing. The additional features of FIGS. 12A and 12B include a curving sloped leading face 1210 to the first end, to assist with sliding the connector 1200 into the end of a channel, and to enable the face of the leading edge 1210 to rest against the base of a channel, in the case that the connector is used to engage with a raked ceiling through the opening into the channel. A slot 1220 is provided in the leading edge 1210, through which a screw can be driven to engage with the base of the channel (and the ceiling above), securing the connector 1200 into the channel. The slot 1220 extends longitudinally along the connector, following the curve of the sloped leading edge. As a result, a screw can be appropriately positioned within the slot to be driven into the base of the channel, depending on the angle of the raked ceiling. A relatively shallow curve to the sloped leading edge will permit angles of between approximately 30° (more preferably 32°) and approximately 45° to be catered for. Visual indicating arrows 1230 are provided to more clearly identify the minimum insertion point. External ribs 1240 are provided to improve engagement with the inside of the channel. Finally, internal supporting ribs are provided in a “X”/multiple “V” pattern, to make the connector more rigid. Generally, it will be appreciated that each of the connectors 1000, 1100 and 1200 are hollow, effectively defining an open shell which can be lifted directly off a mould, to make the moulding process as simple as possible and reduce weight and materials cost. These connectors therefore provide various different rib configurations to provide the strength and rigidity required.

Referring to FIGS. 12C and 12D, these show the connector 1200 located within a raked ceiling channel 1260 (indicated by dashed lines—the bottom dashed line representing the position of the nearside lip, the top two dashed lines representing the position of the base of the channel). Typically, a raked ceiling will have an angle with respect to the horizontal of between 32° and 45°. It is desirable that the connector 1200 be able to cater for any angle within this range. In both FIGS. 12C and 12D the connector is shown upright, as it would be if projecting from the top of a stud channel. It can be seen that in FIG. 12C the connector 1200 is at a shallower angle with respect to the channel 1260 than in FIG. 12D, which will correspond to a higher pitch (45°) rake to the ceiling channel if the connector 1200 is installed vertically within a stud. In FIG. 12D, the pitch of the raked ceiling would be approximately 32°. In order to achieve this range of angles, the connector 1200 comprises a pair of engagement formations 1270 and 1272, respectively further from and nearer to the curved sloping end 1210 of the connector 1200. As can be seen in FIGS. 12C and 12D, a lip 1262 of the channel 1260 into which the connector is being inserted is trapped between the pair of engagement formations 1270 and 1272. This engagement is achieved by urging the formations (on each side of the connector) 1270 past the lips 1262 and into the channel 1260. The lips 1262 are forced apart by the passage of the formations 1270, and then return once the formations 1270 have passed the lips. The lips 1262 are then located between the formations 1270, 1272. This is similar to the principles described elsewhere herein, in which the lips are forced apart and then drop into a groove or other engagement structure to lock or trap the connector into the channel. In FIG. 12C, the angle between the connector 1200 and the channel 1260 is at a minimum—the lip 1262 is resting along a surface of the formation 1270, but is also in contact with a surface of the formation 1272. Further rotation of the connector 1200 clockwise when viewing FIG. 12C is inhibited. When in this position, the user can screw through the slot 1220 from the underside of the connector and into the base 1264 of the channel, and into the ceiling above, fixing the connector at this angle. Turning to FIG. 12D, it can be seen here that at this steeper angle the lip 1262 of the channel is resting along a surface of the formation 1272. The formation 1270 is not engaged with the lip in this case, but instead further rotation anticlockwise when viewing FIG. 12D (that is, rotating the connector to make the angle between the connector 1200 and the raked ceiling channel 1260 greater) is inhibited by the curved sloping face 1210 abutting the base 1264 of the channel. The distance from the formation 1272 to the extreme leading edge of the connector is greater than the depth of the channel 1260 (from the base 1264 to the lip 1262), which limits the available angle.

It will be appreciated that the formations 1270 and 1272 are provided also on the other side of the connector 1200, to engage with the other lip of the channel 1260. The formations 1270 and 1272 therefore enable raked ceiling angle adjustment, so that the one connector design covers the required range of 32° to 45°. The groove running vertically from the formation 1270 serves to keep wall thicknesses fairly constant, which helps with manufacturability by achieving a fairly consistent degree of shrinkage of the moulding as it cools. Also visible in FIG. 12D is the groove 1280 extending around at least the upper and side surfaces of the connector 1200, to enable the end of the connector 1200 distal from the sloped end to be used as a twist-type connector as described above. The connector also comprises a recess 1290 on each side of the connector which enable twist locking engagement with a channel at half-depth, permitting two connectors to be fitted at (for example) approximately mid height to a stud, for noggin or pattress purposes (provided there is a suitable cut-out in the stud channel), with the result that they can be at the same height as each other such that the noggin/pattress is effectively continuous across the stud, rather than stepping from one height to another. This principle is demonstrated in FIGS. 9B, 10B and 11B.

Referring to FIGS. 13A to 13C, an angled connector 1300 is shown. This connector has an angled joint which can be adjusted to achieve angles of between 0° and 90° in 5° increments. The angled joint is achieved using a serrated interface. In FIG. 13A, the angled connector can be seen to comprise two separate parts, 1310 and 1320. The two parts can be coupled together by pressing a connection portion 1340 of the part 1310 against a complementary connection portion (not shown) of the part 1320. The connection portion 1340 comprises angled ratcheting ribs at 5° increments, which engage with similar ribs or grooves on the complementary connection portion. The connection portions of the two parts are lined up at the desired angle, pressed together, and then a screw 1360 is driven into a screw hole in the second part 1320, and through into a screw hole 1330 in the first part 1310, thereby fastening the two parts 1310, 1320 together at a desired angle with respect to each other. The part 1310 comprises a smaller cross section end part 1312 which can be twist-locked into a channel, and a larger cross section part 1314 which matches the internal dimensions of a channel to be slid into an end thereof. Similarly, the part 1320 comprises a smaller cross section end part 1322 which can be twist-locked into a channel, and a larger cross section part 1324 which matches the internal dimensions of a channel to be slid into an end thereof. FIG. 13B shows how the assembled connector of FIG. 13A can be used to connect an upright channel (stud) 1380 to a raked ceiling channel 1390, by sliding the part 1310 into the end of the raked ceiling channel 1390 until the larger cross section part 1314 is received in the channel 1390, and by sliding the part 1320 into the end of the upright channel 1380 until the larger cross section part 1324 is received in the upright channel 1380. The connector 1300 could either be assembled when the two parts 1310, 1320 are slid into place in the respective channels, or could be manipulated into the ends of the channels following its assembly. It will be appreciated that the first and second parts each comprise longitudinally extending grooves for engaging with an internal ridge of the channel when the part is slid into an end of the channel, and also comprise a groove for engaging with the lip when the connector is to be twist-locked into place. Referring to FIG. 13C, where it is necessary to connect an upright channel to a raked ceiling channel at a midpoint of the raked ceiling channel, this can be achieved either by twist-locking the upright, with the assembled connector already in place, into the ceiling channel, or by twist-locking one part of the connector into the ceiling channel, sliding the other part of the connector into the upright channel, positioning the upright in place with the joint between the two connector parts lined up, and screwing the two parts of the connector 1300 together.

Referring to FIG. 14, a connector 1400 which is a variant of the connector 1300 is shown. The connector 1400 is identical to the connector 1300, except that each of the connection portions utilises a textured surface 1410 to maintain a desired angle between the first and second parts. It will be appreciated that only one of the parts is shown in FIG. 14, but the other part could be identical, and the two parts would be secured together by a screw, in the same way as for FIG. 13.

Referring to FIGS. 15A to 15D, another two part connector 1500 is illustrated. The two part connector 1500 comprises a first part 1510 and a second part 1520, which can be mounted at an angle to each other via a sliding joint. One or both of the first part 1510 and the second part 1520 may be available with different joint angles, permitting a user to achieve a desired angle between the first and second parts by selecting the appropriate parts. For example, angles of 30° or 45° may be achievable, to be suitable for use with standard raked ceilings. The user forms the assembled connector by sliding the first part 1510 and the second part 1520 together, so that mutually interengaging formations of the sliding joint engage with each other. The first part 1510 provides a sliding fit into a channel, and thus has a cross section which substantially matches the internal dimensions of the channel. The second part 1520 comprises a narrow leading edge 1522 which facilitates its insertion into an open edge of the channel, a ramp 1524 which urges the lips of the channel apart as the connector 1500 is pushed in through the open edge of the channel, and a groove or slot 1526 into which the lips descend when the connector 1500 has been pushed sufficiently far into the channel. The engagement between the lips of the channel and the groove 1526 secures the connector 1500 into the channel. This process is illustrated in FIGS. 15B, C and D. In particular, in FIG. 15B the assembled connector 1500 (of the correct angle) has been slid down into an upright channel 1520, and at the lower end of the upright channel 1520 a straight connector according to any of the embodiments described above is inserted into the lower end of the upright channel, and then twist locked into a floor channel. The connector 1500 is then offered up towards a raked ceiling channel 1530. In FIG. 15C the upright 1520 is slid sideways to engage the connector 1500 in the raked channel. As a result of the ramp 1524, the channel flexes, urging the lips apart to then snap into place in the groove 1526. In FIG. 15D, the position of the upright can be adjusted, and the connector 1500 secured to each of the raked and upright channels with screws.

Referring to FIGS. 16A and 16B, an alternative connector 1600 for engaging with a raked ceiling is illustrated. The connector 1600 comprises a main body section 1620 shaped and dimensioned to slide fit into the end of an upright channel. At the lower end of the main body section 1620, a chamfered lead in 1610 is provide to assist with inserting the main body section 1620 into the end of a channel. A flexible head section 1640 is attached to the main body section 1620 via a living hinge 1630. The living hinge 1630 allows the head section 1640 to flex to any angle (with respect to the main body section 1620) between 0° and 90° . Cut-outs 1650 are provided to either side of the head section 1640, to allow fixing of the connector as a corner piece. Strengthening ribs 1660 are provided in both the main body section 1620 and the head section 1640, with a cutout to each of the ribs allowing tracking of piping and cables down along the connector 1600. As can be seen from FIG. 16B, a further cutout 1670 is provided in the head section 1640 to allow tracking of piping and cabling. Referring to FIG. 16C, the use of the connector 1600 to fix an upright channel to a raked ceiling both at a corner, and at a mid span, are demonstrated. In either case, the main body 1640 is received in the top end of an upright channel 1680, but its orientation within the upright channel 1680 differs. In the case of a mid span fixing (top left hand image), the main body 1640 is received in the upright channel 1680 such that its hollow bottom is exposed through the open edge of the upright channel 1680. The head section 1640 is engaged within the channel, within an internal ridge of the channel engaging into the cutouts 1650. The engagement may be achieved by way of urging the head section 1620 into the channel such that the walls of the channel flex to permit entry of the head section 1620, whereupon the internal ridge of the channel snap into the cutouts 1650 to inhibit the withdrawal of the head section 1620 from the channel 1690. To achieve this, the head section 1620 may be provided with a chamfered lead in. In the case of a corner fixing (bottom left hand image), the main body 1640 is received in the upright channel 1680 such that its hollow bottom is adjacent the base of the channel (that is, rotated 180° with respect to its orientation for mid span fixing). The head 1640 then slides in to the end of the raked ceiling channel 1690.

Referring to FIGS. 17A and 17B, two alternative pattressing connectors 1700 and 1750 are illustrated. The pattressing connector 1700 shown in FIG. 17A comprises a twist lock section 1705 and an offset section 1710. Unlike the connectors previously described, in which use of the connectors result in a stud (for example) being mounted such that it is flush with the floor and ceiling channels, or a noggin which is flush with the stud channels which it extends between, the connector 1700 results in a channel mounted horizontally between two vertical stud channels being offset backwards into the wall cavity, providing a suitable structure for a pattress. This is achieved in the present case because the part of the connector onto which the horizontal channel slides is at 90° to the part of the connector which twists into a vertical channel (stud). As a result, when the twist lock section 1705 is locked into position, the horizontal channel will be rotated at 90° with respect to the vertical channel, presenting its wider face to the plane of the wall. This provides a large surface to fix to. Additionally, the offset section 1710 is also provided towards one side of the twist lock section 1705, rather than being provided centrally, with the result that the horizontal channel can be set further back from the plane of the wall. In the example shown, an offset of 25 mm is provided, should the horizontal channel be slide completely over the offset section 1710. However, the offset section 1710 also bears a number of slots 1720 which allow the horizontal channel to be placed at varying offsets as required. In particular, the slots 1720 are intended to engage with the lips at either side of the open edge of the horizontal channel. It will be noted that friction fit crush ribs 1715 are also provided in order to improve engagement of the offset section 1710 with the inside of a channel into which it is to be slid. In FIG. 17B, a similar arrangement is provided, but rather than providing an offset section with relatively shallow slots for receiving the lips of the channel, an offset section with a set of parallel plates 1760 is provided. In this case either the lips or the base of the channel can be engaged between two adjacent ones of the parallel plates 1760. By selecting the desired pair of plates, the amount of offset can be varied. The plates not required can be cut off or screwed through.

Referring to FIG. 18A, a push type connector 1800 and complementary channel 1850 are shown. First considering the channel 1850, in the drawing at the bottom right of FIG. 18A, this can be seen to be a C-shaped channel having pressed side joggles (formations) which provide the channel with increased strength and which allow flush fitting of countersunk screw heads. The channel 1850 also comprises lips 1870 extending along either side of the open side of the channel. The channel 1850 also comprises a cutout 1880, which is a hole cut into the rear (base wall) of the channel 1850 to allow fitting of pattresses/noggins in either orientation, as will be discussed below. The width (perpendicular to the longitudinal axis of the channel) of the hole may be substantially the same as the width of the opening in the open side of the channel. As mentioned above in relation to FIG. 4, in practice the width of the cut out may be slightly different from the width of the opening to the channel, provided that the groove (or other engagement structure) of the connector is suitably dimensioned to be able to handle both widths. For manufacturing reasons (of the channel), it may be preferable for the cut outs to be a few mm narrower than the opening. The connector 1800 comprises a first end 1810 having a set of bump fitting barbs to engage with the inside of the channel 1850, and in particular to engage with the inside of the joggles 1860. The first end also comprises a groove 1817 into which the lips 1870 of the channel 1850 can extend to trap the connector 1800 within the channel 1850. Unlike the twist lock variants described above, the push type connector 1800 is simply forced into the channel, causing the channel to temporarily deform to permit entry of the connector 1800, before substantially resuming its original shape to trap the connector 1800 in place. More specifically, once the connector 1800 has been inserted sufficiently far into the channel, the lips 1870 will drop into the groove 1817, locking the entire first end 1810 of the connector into the channel 1850. The width d1 of the leading edge of the first end 1810 of the connector 1800 is less than the width d2 of the opening between the lips 1870 of the channel 1850, enabling the insertion of the leading edge of the connector 1800 into the channel 1850. The ramped shape of the first barb will cause the lips 1870 to part and then spring back behind the barb. This will repeat for each barb until the connector 1800 is inserted far enough into the channel 1850 that the lips 1870 spring closed into engagement with the groove 1817, at which point the connector 1800 will be locked in place within the channel. In FIG. 18B, an installation using the connector 1800 is illustrated. At a first stage, floor and ceiling channels are mounted to the floor and ceiling respectively. Then, at a second stage, the connector 1800 is slid into the end of a stud channel. This occurs once for each end of the channel. The connector 1800 can be slid entirely into the stud channel so that it does not protrude, as shown in the image of the third step. In the third step, the stud channel is aligned with the ceiling channel, and at the fourth stage, the connector 1800 is slid upwards and pressure applied to bump fit it into the ceiling channel, as described above. The third and fourth stages are repeated for the floor channel. The studwork can then be secured with screws in the fifth stage, by screwing through from the outside of the floor (and ceiling) channels into the connector. At a sixth stage, noggins are fitted between the studs in the same way, with the noggin channels receiving a connector in each end by a sliding action, lining the noggin channel up horizontally between two adjacent studs, and then sliding the connectors sideways to engage with each of the two adjacent studs. In order to achieve this, it may be necessary for the connector to be accepted through the cutout 1880 in the channel 1850.

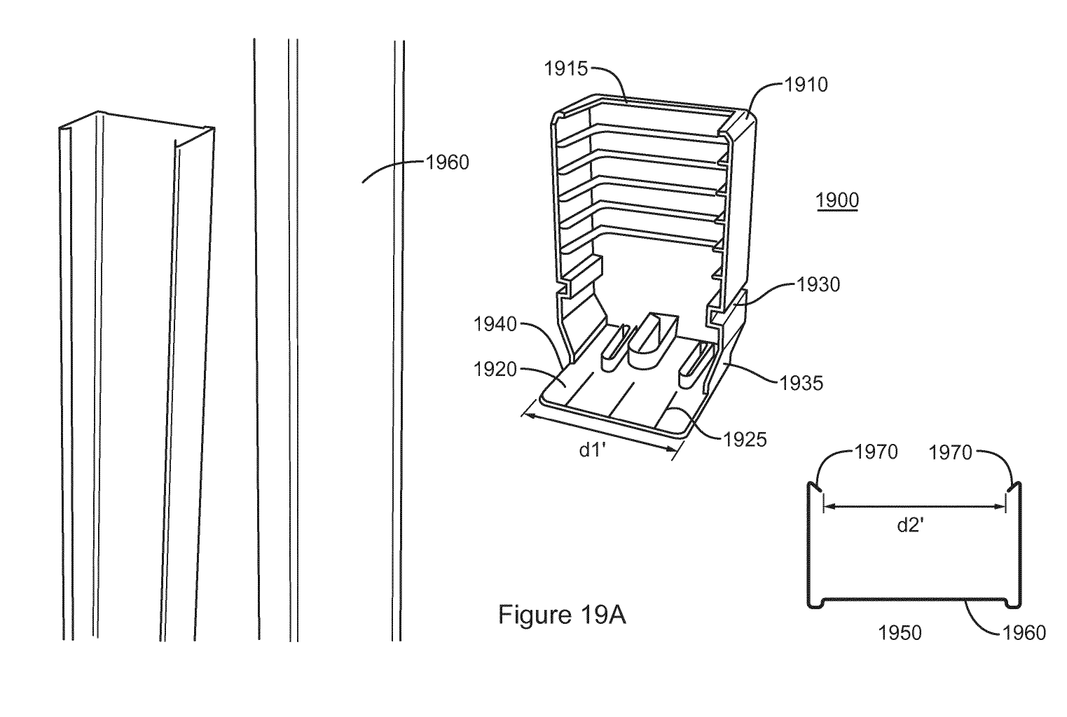

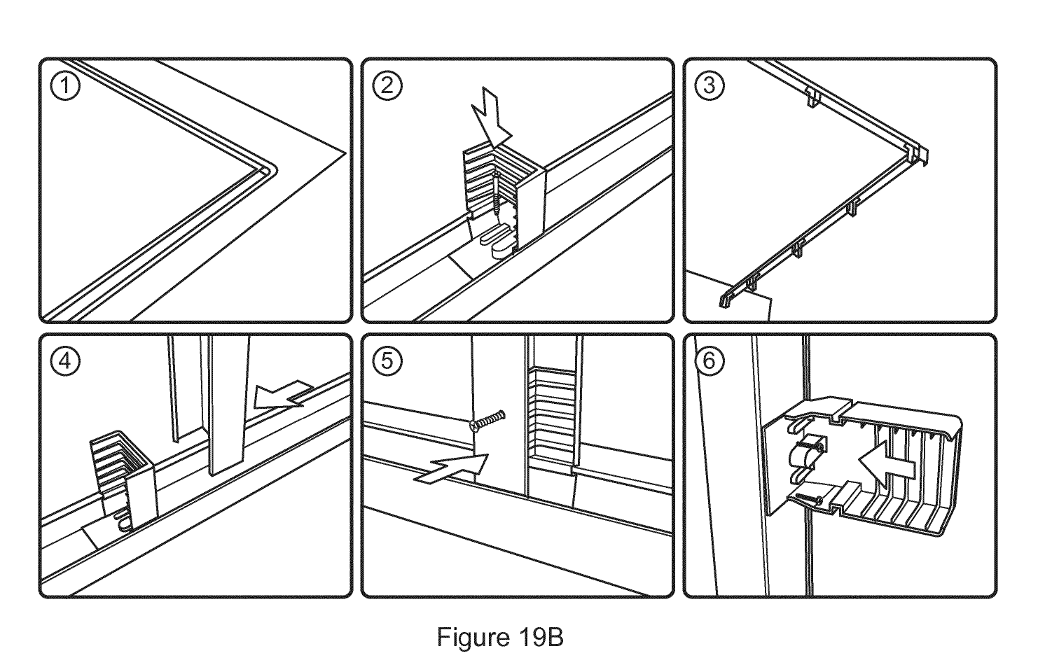

Referring to FIGS. 19A and 19B a push type connector 1900 and complementary channel 1950 are shown. First considering the channel 1950, in the drawing at the bottom right of FIG. 19A, this can be seen to be a C-shaped channel having lips/rolled edges 1970 and a pressed channel part 1960 to increase the strength of the channel and to allow flush fitting of the connector 1900 when mounted to the reverse (external) face. The connector 1900 comprises a chamfered lead in for ease of (slide) fitting into the end of the channel 1950, and strengthening ribs 1915. The connector 1900 also comprises a base plate 1940 which can be screw mounted to the base of the channel 1950—and in particular either to the face of the base on the inside of the channel 1950, or the reverse face on the exterior of the channel. The base plate 1940 comprises chamfered countersunk screw mounting slots 1920 for fixing the connector 1900 to the base of the channel 1950. The use of slots permits minor adjustments to be made. To assist with fixing, screw mounting guides 1925 are provided. The connector 1900 also comprises a bump fit groove 1930 into which the rolled edges 1970 of the channel will snap. A ramp portion 1935 is also provided, to urge the rolled edges 1970 apart as the connector 1900 is pushed between them. It will be understood that the width of the base plate 1940 d1′ is preferably less than the width d2′ of the opening to the channel 1950, although the rolled nature of the edges may assist with permitting the base plate 1940 access. As the connector 1900 is further pressed into the channel, the rolled edges 1970 are urged apart as they climb the ramp 1935, and then snap into the groove 1930. This arrangement is not intended to firmly fix the connector in place, but to merely retain it in position until its position can be adjusted and fixed with the use of screws, or boards are fixed. In FIG. 19B, six stages describing the use of the connector 1900 are illustrated. In the first stage, floor channels are laid out. Then, at a second stage the connector (and other connectors) are pushed into the floor channel and secured in position in the floor channel with screws or ground anchors. Since the connectors are being screwed through the channel and into the floor, it may not be necessary to separately screw the floor channel to the floor. At a third stage, a corresponding ceiling channel is laid out, and connector mounted in place—in positions directly above counterpart connectors in the floor channel. At a fourth stage the upright studs are clicked in place over the connectors, in the direction shown. In the present case the connectors are not slid into the end of the channels (although they could be), but the rolled edges of the upright channels move apart to permit entry of the connector, and then close around the connector once the connector is fully received within the channel. At a fifth stage the studwork may be secured with screws, if required. At a sixth stage, pattressing or noggin connectors (these are described further below) can be screwed on the reverse of the stud channels, and the noggin or pattressing channels urged over the horizontally mounted mounted connectors in like manner to the fourth stage. It will be noted that the connector is mounted at a 90° rotation with respect to the orientation it would have if being inserted into the channel rather than be affixed to the rear of the channel. Referring to FIG. 20, three variations of the connector 1900 are shown. The connector on the left is the connector shown in FIG. 19. This provides (in this example) a 25 mm offset for pattressing when mounted to the rear of a channel in the manner shown in FIG. 19B. Additionally, the base rib 1010 can be cut or snipped off to give an adjustable offset for pattressing. The middle connector can be seen to have a shorter base rib, providing a 12 mm (in this example) offset for pattressing. The connector on the right has a slightly longer base rib than the middle connector, providing a 15 mm (in this example) offset for pattressing. Each of the connectors has slots 2020 at either side of the main slot to receive bracing screws.

Generally, the use of the connectors described above permits horizontal, vertical and angled channels to be coupled together in a manner which results in a substantially flush surface. This is because the channels are aligned with each and connected with each other via the intermediary of the connectors, which fits inside the connectors (either by way of sliding, twisting or forcing). This makes applying plasterboard to a frame assembled in this way much easier, and improves the flatness of finish.

Referring to FIGS. 21A to 21 D, a channel to channel twist engagement structure and method is shown. In FIG. 21A, a first channel 2000a can be seen to comprise a main section 2010, which is a C-shaped channel similar to that described above. At one end of the main section 2010 is an engagement section 2020, which comprises a groove 2030.

The length of the engagement section 2010 (in the direction of the longitudinal axis of the channel) is less than or preferably substantially equal to the depth of a channel 2000b (see FIG. 21 B) into which it is to be inserted, from the base of the channel 2000b, to the lips or rolled edges 2040 extending along each side of an opening. In FIG. 21 B, the channel 2000a is aligned in a first orientation with the open face of the channel 2000b, and is lowered into the channel 2000b. In FIG. 21 C, it can be seen that the channel 2000a is then rotated with its engagement section 2010 within the channel 2000b, which engages the lips or rolled edges 2040 with the groove 2030. It should be noted that the other end of the channel 2000a preferably does not have an engagement section, but instead is used with one of the twist or push connectors described above. In this case the single connector copes with any tolerances or deflection of the ceiling.

From the above, it will be appreciated that a connector is provided which slideably engages with an end of a channel (elongate member) at one end, and which engages with the lips extending along another channel its other end. The engagement with the lips may be via a twist-lock type engagement, or via a snap/push-lock engagement (where the connector is urged or forced in between the lips, until the lips engage with a structure—e.g. a groove—of the connector. In relation to the end providing slideable engagement, the connector need not necessarily be inserted/slid into the end of a channel to engage the connector with the channel, but might instead be forced in between the lips—with the rolled edges or lips of the upright channels moving apart to permit entry of the connector, and then closing around the connector once the connector is fully received within the channel.

It will also be understood that both ends of the connector may be slideably engageable with a channel (for example because the connector has suitable cross sectional dimensions to permit it to fit wholly and slideably within the channel when lined up longitudinally with the channel), and both ends may also be capable to twist or push engagement with the lips of a channel—for example one end may be shaped for twist locking engagement while the other end is shaped for push locking engagement and/or angled engagement.

While embodiments of the present invention have been described above in relation to a stud wall, the invention is widely applicable to many other structures, for example in new build residential and new build commercial, potentially spanning from DIY to professional installation and refurbishment. In addition to metal framed drywall partition systems, embodiments of the present invention can be used for ceiling framing and access flooring.

1. A connector for connecting together first and second elongate members, each of the members comprising an open channel extending along the member, the channel having an opening along one side of the member and being partially enclosed by a lip extending along the opening, the connector comprising:
a first end portion shaped to fit into the channel of the first member via one end of the first member; and
a second end portion shaped to permit its insertion into the channel of the second member via the opening when the connector is in a first rotational position with respect to the second member, the second end portion comprising a first engagement structure which is shaped to engage with the lip of the second member when the inserted connector is rotated within the channel from the first rotational position into a second rotational position with respect to the second member.

2. A connector according to claim 1, wherein the second end portion is dimensioned to be trapped within the channel by the lip when the connector is rotated within the channel.

3. A connector according to claim 1, wherein the first engagement structure comprises a groove which is shaped and positioned to engage with the lip when the connector is inserted into the channel and rotated from the first rotational position into the second rotational position.

4. A connector according to claim 3, wherein the groove extends around at least a portion of the connector at a distance from an end of the connector substantially equal to the depth of the channel.

5. A connector according to claim 3, wherein the groove comprises a gripping formation for gripping the lip when the connector is in its first rotational position.

6. A connector according to claim 2, wherein the cross section of the first end portion is dimensioned to substantially match the internal cross section of the channel.

7. A connector according to claim 1, wherein the cross section of the second end portion has a first dimension which is less than or equal to the width of the opening to the channel and a second dimension perpendicular to the first dimension which is greater than the width of the opening to the channel.

8. A connector according to claim 6, wherein the second dimension is substantially equal to the internal width of the channel, such that the second end portion of the connector substantially fills the width of the channel when the connector is in its second rotational position.

9. A connector according to claim 1, wherein the first and second elongate members are C channels.

10. A connector according to claim 1, wherein the angular displacement of the second rotational position from the first rotational position is 90°.

11. A connector according to claim 1, wherein the cross section of the second end portion is generally rectangular, and at least two opposite edges of the connector along at least a portion of its length are bevelled to permit rotation of the second end portion within the channel.

12. A connector according to claim 1, wherein the second end portion is engageable with the channel via a cut out in a face of the second member opposite to the face in which the opening is provided.

13. A connector according to claim 1, wherein the engagement structure comprises a tapered slot which is shaped and positioned to engage with the lip when the connector is inserted in to the channel and rotated from the first rotational position to the second rotational position, the tapered shape serving to guide the lip as it enters the notch into a narrow portion of the slit which grips both sides of the lip.

14. A connector according to claim 13, wherein two notches are provided, one in each of two opposite edges of the connector.

15. A connector according to claim 1, wherein the first end portion and the second end portion have substantially the same shape.

16. A connector according to claim 1, wherein the connector comprises a channel or cavity for permitting electrical wiring to pass through a joint, formed by the connector, between the first and second members.

17. A connector according to claim 1, wherein the connector and the inside of the channel of the first member are provided with serrated formations for restricting a slideable engagement between the connector and the first member.

18. A connector according to claim 1, wherein one or both of the first end and the second end of the connector have a radiused or chamfered leading edge to facilitate insertion into the first and/or second elongate members.

19. A connector according to claim 1, wherein the first end comprises one or more external ribs for providing friction engagement with the inside of the channel of the first elongate member.

20. A connector according to claim 1, wherein the first end comprises a plurality of slots extending from an end face of the first end of the connector longitudinally of the connector.

21. A connector according to claim 1, wherein the first end of the connector and the second end of the connector are hingedly connected together.

22. A connector according to claim 1, wherein the connector is formed of two separate moulded components, one of the components comprising the first and a first hinge part, and the other of the components comprising the second end and a second hinge part, the first hinge part and the second hinge part being engageable to permit the angle between the first end and the second end to be adjusted.

23. A connector according to claim 22, wherein each of the first and second parts comprise mutually engaging formations or textured surfaces which can be engaged with each other at different angles.

24. A connector according to claim 1, wherein the first end is provided with markings indicating a minimum insertion depth for the first end into the first member.

25. A connector according to claim 1, wherein the leading face of the second end comprises hollows or cutouts for clearing screwheads within the channel of the second member.

26. A connector according to claim 1, wherein the second end comprises a further engagement structure nearer to its leading face.

27. A connector according to claim 1, wherein the first end has a curved and sloped leading face which can abut a base wall of the channel at a range of angles.

28. A connector according to claim 27, wherein the curved and sloped leading face bears a slot for receiving a screw to fix the connector to the base of the channel at a desired angle of the range of angles.

29. A connector according to claim 27, further comprising one or more formations, shaped and positioned to interact with the lip of the channel to restrict the connector, when its sloped leading face is within the channel, from having an angle with respect to the channel of greater than a first predetermined angle and/or less than a second predetermined angle.

30. A connector according to claim 29, wherein the first predetermined angle is approximately 45° and the second predetermined angle is approximately 32°.

31. A connector according to claim 29, wherein the connector is inhibited from exceeding the first predetermined angle when the lip is in contact with one of the formations and the leading edge of the connector is in contact with the base of the channel.

32. A connector according to any one of claims 29, wherein the formations comprise a first formation and a second formation, and wherein the connector is inhibited from having an angle less than the predetermined angle when the lip is trapped between the first and second formations.

33. A connector for connecting together first and second elongate members, each of the members comprising an open channel extending along the member, the channel having an opening along one side of the member, the connector comprising:
a first end portion shaped to fit into the channel of the first member via one end of the first member; and
a second end portion shaped to permit its insertion under pressure into the channel of the second member via the opening, the second end portion comprising a first engagement structure which is shaped to engage with a second engagement structure of the second member when the second end of the connector has been inserted through the opening.

34. A connector according to claim 33, wherein the opening along one side of the member is partially enclosed by a lip extending along the opening, and wherein the lip is the second engagement structure.

35. A connector according to claim 34, wherein the engagement structure comprises a groove which is shaped and positioned to engage with the lip when the second end of the connector is inserted a predetermined distance through the opening.

36. A connector according to claim 35, wherein the groove extends around at least a portion of the connector at a distance from an end of the connector substantially equal to the depth of the channel.

37. A connector according to claim 33, wherein the second end comprises a ramped leading end which displaces the lips of the channel apart as the connector is urged into the channel, wherein the groove is disposed behind the ramp.

38. A connector according to claim 33, wherein the second end of the connector comprises an end plate which rests against the inside surface of the channel opposite to the opening when the second end of the connector is fully inserted through the opening.

39. A connector according to claim 38, wherein the end plate is provided with fixing holes for fixing the connector to or through the surface of the channel against which the end plate rests.

40. A connector according to claim 38, wherein the end plate is shaped and dimensioned to rest in a recess in an external face of the second member opposite to the face in which the opening is provided.

41. A connector according to claim 37, wherein the second end comprises a plurality of barbs for engaging with the inside side walls of the channel of the second member.

42. A connector according to claim 33, wherein the connector is formed of moulded plastic.

43. A frame structure, comprising a plurality of elongate members joined together by one or more connectors according to claim 33.

44. A wall, ceiling or floor comprising a frame structure according to claim 43.

45. A method of connecting together first and second elongate members, each of the members comprising an open channel extending along the member, the channel having an opening along one side of the member, the method comprising the steps of:
sliding a shaped first end portion of the connector into the channel of the first member via one end of the first member;
inserting a shaped second end portion into the channel of the second member via the opening with the connector in a first rotational position with respect to the second member; and
rotating the inserted connector within the channel from the first rotational position into a second rotational position with respect to the second member so that a first engagement structure of the connector engages with a second engagement structure of the second member.

46. A method of connecting together first and second elongate members, each of the members comprising an open channel extending along the member, the channel having an opening along one side of the member, the method comprising the steps of:
sliding a shaped first end portion of the connector into the channel of the first member via one end of the first member;
inserting under pressure a shaped second end portion into the channel of the second member via the opening, the second end portion comprising a first engagement structure which is shaped to engage with a second engagement structure of the second member when the second end of the connector has been inserted through the opening.

47. A method of constructing a frame structure, comprising the step of connecting together a plurality of elongate members using the steps of claim 45.

48. (canceled)

49. The connector as described in claim 33 wherein the connector is used as part of a frame structure, wall, ceiling or floor.

50. (canceled)
